(19) United States
(12) Patent Application Publication
(10) Pub. No.: US 2026/0025025 A1
(43) Pub. Date: Jan. 22, 2026

(54) TOILET SEAT DEVICE

(71) Applicant: TDK Corporation, Tokyo (JP)

(72) Inventors: Kazuyoshi HANABUSA, Tokyo (JP); Masayuki YAMASHIMA, Tokyo (JP)

(73) Assignee: TDK Corporation, Tokyo (JP)

(21) Appl. No.: 18/998,046

(22) PCT Filed: Mar. 31, 2023
(86) PCT No.: PCT/JP2023/013467

§ 371 Date: Jan. 23, 2025

Related U.S. Application Data
(60) Provisional application No. 63/392,563, filed on Jul. 27, 2022.

(51) Int. Cl. H02J 50/12; A47K 13/30; H02J 50/00

(52) U.S. Cl. CPC H02J 50/12; A47K 13/305; H02J 50/005

(57) ABSTRACT

A toilet seat device includes: a toilet seat part; and a main body part wherein the toilet seat part is mounted to be attachable and detachable, wherein the main body part transmits electric power to the toilet seat part using wireless power transmission, the toilet seat part receives electric power from the main body part using wireless power transmission and includes a load to which the electric power received from the main body part is supplied, and at least one of the toilet seat part and the main body part includes an output adjusting unit adjusting a power value of electric power output to the load by the toilet seat part without using wireless communication between the toilet seat part and the main body part.

Priority is claimed on U.S. Patent Application No. 63/392,563, filed Jul. 27, 2022, the content of which is incorporated herein by reference.

### TECHNICAL FIELD

The present disclosure relates to a toilet seat device.

### BACKGROUND ART

Toilet seat devices including a heater receiving power from a power supply and heating a heating target have been researched and developed.

Regarding this, a toilet seat device, which includes a heater that receives power from a power supply and heats a heating target, a switch that performs connection/disconnection between the power supply and the heater, a control means that sets a target electric conduction ratio according to a request for heating within a range not exceeding a conduction ratio upper limit value of the heater when the request for heating the heating target is made and performs heating control for controlling a switch such that the heater is caused to be conductive with the target electric conduction ratio, and a current sensor that detects a current flowing through the heater is known, in which the control means performs constant ratio conduction control of performing control of the switch such that the heater is electrically conductive with a constant conduction ratio set in advance at a predetermined time at which heating control is not performed and sets a conduction ratio upper limit value based on a current detected by the current sensor while performing this constant ratio conduction control (see Patent Document 1).

### CITATION LIST

### Patent Document

### Patent Document 1

Japanese Unexamined Patent Application, First Publication No. 2019-199689

### SUMMARY OF INVENTION

### Technical Problem

Here, in a toilet seat device having a shower function for washing a person's buttocks, there is a request for washing a toilet seat part including a heater while it is detached from a main body part supplying power to the toilet seat part. As one method for realizing this, there is a method in which power supply to a toilet seat part from a main body part is performed using wireless power transmission. However, in a case in which power supply from the main body part to the toilet seat part is performed simply using wireless power transmission, control of electric power supplied to a heater needs to be performed wirelessly from the main body part to the toilet seat part. In this case, the toilet seat device needs to have a wireless function, which is not desirable because it causes an increase in the number of components and the like. In this specification, the wireless power transmission is wireless transmission of electric power.

The present disclosure is in consideration of such a situation, and an object thereof is to provide a toilet seat device capable of performing control of electric power supplied to a load included in a toilet seat part that can be detached from a main body part while suppressing an increase in the number of components.

### Solution to Problem

According to one aspect of the present disclosure, there is provided a toilet seat device including: a toilet seat part; and a main body part on which the toilet seat part is mounted to be attachable and detachable, in which the main body part transmits electric power to the toilet seat part using wireless power transmission, the toilet seat part receives electric power from the main body part using wireless power transmission and includes a load to which the electric power received from the main body part is supplied, and at least one of the toilet seat part and the main body part includes an output adjusting unit adjusting a power value of electric power output to the load by the toilet seat part without using wireless communication between the toilet seat part and the main body part.

### Advantageous Effects of Invention

According to the present disclosure, electric power supplied to a load included in a toilet seat part that can be detached from a main body part can be controlled while an increase in the number of components is inhibited.

### BRIEF DESCRIPTION OF DRAWINGS

FIG. 1 is a diagram illustrating one example of the configuration of a toilet seat device 1 according to an embodiment.

FIG. 2 is a diagram illustrating one example of timings at which an inverter 21 in operation starts an output period T1 and starts a non-output period T2.

FIG. 3 is a diagram illustrating one example of a flow of the process of adjusting a power value of the DC power output to a load LD by the toilet seat part 10 according to the embodiment.

FIG. 4 is a diagram illustrating one example of the configuration of a toilet seat device 1 according to Modified Example 1 of the embodiment.

FIG. 5 is a diagram illustrating one example of the configuration of a toilet seat device 1 according to Modified Example 2 of the embodiment.

FIG. 6 is a diagram illustrating one example of a flow of the process of adjusting DC power output to a load LD by a rectification circuit 12 of a toilet seat part 10 according to Modified Example 1 of the embodiment.

FIG. 7 is a diagram illustrating one example of the configuration of a toilet seat device 1 according to Modified Example 3 of the embodiment.

FIG. 8 is a diagram illustrating one example of the configuration of a toilet seat device 1 according to Modified Example 4 of the embodiment.

FIG. 9 is a diagram illustrating one example of a flow of the process of a toilet seat part 10 according to Modified Example 6 of the embodiment adjusting DC power output to a load LD.

FIG. 10 is a diagram illustrating one example of a flow of the process of a second output adjusting unit 14 switching control of a DC/DC converter 13 between constant voltage control and constant power control.

FIG. 11 is a diagram illustrating one example of a flow of the process of the second output adjusting unit 14 controlling the DC/DC converter 13 using constant voltage control.

### DESCRIPTION OF EMBODIMENTS

### Embodiment

Hereinafter, an embodiment of the present disclosure will be described with reference to the drawings. In the present disclosure, a conductor transmitting an electric signal according to DC power or an electric signal according to AC power will be referred to as a transmission line in description. The transmission line, for example, may be a conductor printed on a board, a conductive line in which a conductor is formed in a linear shape, or any other conductor. In addition, in the present disclosure, when a voltage is referred to, it represents an electric potential difference from an electric potential serving as a predetermined reference, and illustration and description of the electric potential serving as the reference will be omitted. Here, the electric potential serving as the reference may be any electric potential. In the present disclosure, as one example, a case in which the electric potential serving as the reference is a ground electric potential will be described. In the present disclosure, a magnitude of a certain voltage will be referred to as a voltage value of this voltage in description. In addition, in the present disclosure, a magnitude of a certain current will be referred to as a current value of this current in description. In the present disclosure, a magnitude of certain power will be referred to as a power value of this power in description.

### Overview of Toilet Seat Device

First, an overview of a toilet seat device according to this embodiment will be described.

The toilet seat device according to the embodiment includes a toilet seat part and a main body part to which the toilet seat part is detachably attached. The main body part transmits electric power to the toilet seat part through wireless power transmission. The toilet seat part receives electric power from the main body part through wireless power transmission and includes a load to which electric power received from the main body part is supplied. At least one of the toilet seat part and the main body part includes an output adjusting unit that adjusts a power value of electric power output to the load by the toilet seat part without using wireless communication between the toilet seat part and the main body part.

In accordance with this, the toilet seat device according to the embodiment can adjust the power value of electric power output to the load by the toilet seat part without including a member related to wireless communication between the toilet seat part and the main body part. As a result, this toilet seat device can control electric power supplied to the load included in the toilet seat part that can be detached from the main body part while inhibiting an increase in the number of components.

Hereinafter, the configuration of the toilet seat device according to the embodiment and a process performed by this toilet seat device will be described in detail.

### Configuration of Toilet Seat Device

Hereinafter, the configuration of the toilet seat device according to the embodiment will be described using a toilet seat device 1 as one example of the toilet seat device according to the embodiment.

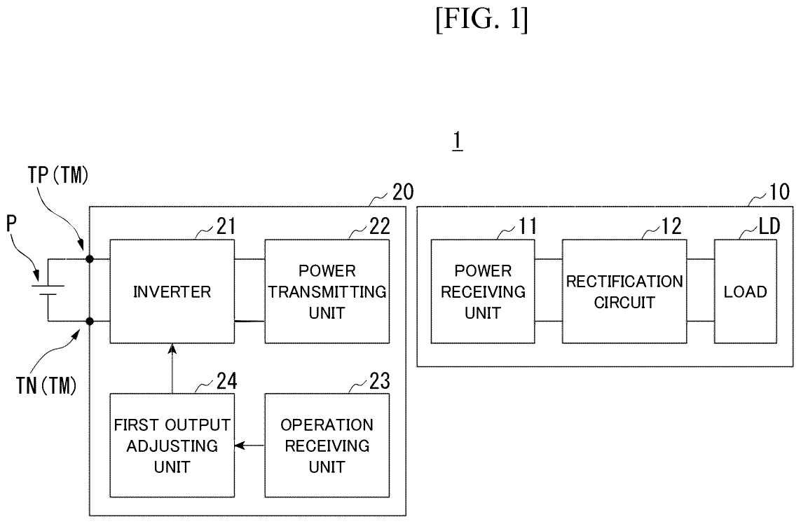

FIG. 1 is a diagram illustrating one example of the configuration of the toilet seat device 1 according to the embodiment.

The toilet seat device 1 includes a toilet seat part 10 and a main body part 20.

The toilet seat part 10 is a member that comes in contact with a user's buttocks in a case in which the user uses the toilet seat device 1. The toilet seat part 10 is mounted on the main body part 20 to be attachable and detachable. The toilet seat part 10 receives an AC voltage from the main body part 20 through wireless power transmission. In addition, the toilet seat part 10 includes a load LD to which a DC voltage according to an AC voltage received from the main body part 20 is supplied. The load LD is a heater, a battery charger, or the like but is not limited thereto. Here, the load LD is preferably a load such as a heater or a battery charger that performs an operation according to an integral value of supplied electric power without being influenced by an intermittent operation of an inverter 21 to be described below. Hereinafter, as one example, a case in which the load LD is a heater that warms a casing, which is not illustrated, of the toilet seat part 10 will be described. In addition, the load LD may be a load to which an AC voltage received from the main body part 20 is supplied instead of a load to which a DC voltage is supplied. In such a case, the load LD may be a load including a circuit unit that converts an AC voltage into a DC voltage or may be a load driven using an AC voltage.

The toilet seat part 10, for example, as illustrated in FIG. 1, includes a power receiving unit 11 and a rectification circuit 12 in addition to the load LD. In addition, the toilet seat part 10 may be configured to include another member, another device, and the like in addition to the power receiving unit 11, the rectification circuit 12 and the load LD.

The power receiving unit 11 may have any configuration, as long as it is a configuration capable of receiving an AC voltage from the main body part 20 through wireless power transmission. For example, the power receiving unit 11 is configured to include a power reception-side resonant circuit including a power receiving coil. The power receiving coil is a coil functioning as an antenna for wireless power transmission. The power receiving coil receives an AC voltage from the main body part 20 via an AC magnetic field generated by the main body part 20. The power reception-side resonant circuit is a resonant circuit that includes one or more capacitors together with the power receiving coil.

The power receiving unit 11 is connected to the rectification circuit 12. The power receiving unit 11 outputs the received AC current to the rectification circuit 12.

The rectification circuit 12 is a circuit that converts the AC voltage received by the power receiving unit 11 into a DC voltage. More specifically, the rectification circuit 12 rectifies the AC voltage received by the power receiving unit 11 into a pulsating voltage and smooths the rectified pulsating voltage, thereby converting the AC voltage into a DC voltage. The rectification circuit 12 may have any configuration as long as it is a configuration capable of performing such conversion of an AC voltage into a DC voltage.

The rectification circuit 12 is connected to the load LD described above. The rectification circuit 12 outputs a DC voltage after transformation to the load LD. In accordance with this, the rectification circuit 12 outputs DC power to the load LD. In addition, in a case in which a load to which the AC voltage received from the main body part 20 is supplied is the load LD, for example, the rectification circuit 12 may be configured to be integrated with the load LD. Furthermore, in a case in which a load driven using the AC voltage received from the main body part 20 is the load LD, for example, the toilet seat part 10 may be configured not to include the rectification circuit 12.

The main body part 20 is mounted on a toilet and is a member on which the toilet seat part 10 is mounted to be attachable and detachable. The main body part 20 supplies electric power to the toilet seat part 10 through wireless power transmission.

The main body part 20 includes a power supply terminal TM, an inverter 21, a power transmitting unit 22, an operation receiving unit 23, and a first output adjusting unit 24.

The power supply terminal TM is a terminal to which a DC voltage is supplied from a power supply P that is configured separately from the toilet seat device 1. The power supply P is a DC power supply capable of supplying a DC voltage and, for example, is an AC (Alternating Current)/DC (Direct Current) converter connected to an external commercial power supply or the like. The power supply terminal TM is configured to include a positive electrode-side power supply terminal TP connected to a positive electrode-side power supply terminal out of terminals included in the power supply P and a negative electrode-side power supply terminal TN connected to a negative electrode-side power supply terminal out of the terminals included in the power supply P.

The inverter 21 is connected to the power supply P through the power supply terminal TM. The inverter 21 converts a DC voltage supplied from the power supply P into an AC voltage having a drive frequency of the inverter 21.

The inverter 21 is connected to the power transmitting unit 22. The inverter 21 outputs the AC voltage after conversion to the power transmitting unit 22.

In addition, the power supply P may be an external commercial power supply or the like. In this case, the main body part 20 includes an AC/DC converter that converts an AC voltage supplied from the power supply P into a DC voltage having a desired voltage value. This AC/DC converter is connected between the power supply terminal TM and the inverter 21 and outputs the DC voltage after conversion to the inverter 21.

The power transmitting unit 22 may have any configuration as long as it is a configuration capable of transmitting an AC voltage to the toilet seat part 10 through wireless power transmission. For example, the power transmitting unit 22 is configured to include a power transmission-side resonant circuit that includes a power transmitting coil. The power transmitting coil is a coil functioning as an antenna for wireless power transmission. The power transmitting coil generates an AC magnetic field and transmits an AC voltage to the toilet seat part 10. The power transmission-side resonant circuit is a resonant circuit that includes one or more capacitors together with the power transmitting coil.

The operation receiving unit 23 receives an operation from a user. For example, the operation receiving unit 23 includes three hardware buttons receiving operations for setting target temperatures that become targets with which the temperature of the casing of the toilet seat part 10 is caused to coincide. These three hardware buttons are three buttons, for example, including a first button associated with a first target temperature, a second button associated with a second target temperature, and a third button associated with a third target temperature. Here, the first target temperature is the highest temperature among temperatures that can be set as target temperatures, and is, for example, 40° C., but may be a temperature higher than 40° C. or a temperature lower than 40° C. The second target temperature is the second highest temperature among temperatures that can be set as target temperatures, and is, for example, 35° C., but may be a temperature higher than 35° C. or a temperature lower than 35° C. The third target temperature is the lowest temperature among temperatures that can be set as target temperatures, and is, for example, 30° C., but may be a temperature higher than 30° C. or a temperature lower than 30° C. In addition, the operation receiving unit 23 may be configured to include another button, another lever, and the like in addition to these three buttons or may be configured as a touch panel.

The first output adjusting unit 24 intermittently operates the inverter 21. The intermittent operation of the inverter 21 is an operation of the inverter 21 alternately repeating the output period T1 and the non-output period T2. The output period T1 is a period in which an AC voltage is output from the inverter 21 to the power transmitting unit 22. The non-output period T2 is a period in which an AC voltage is not output from the inverter 21 to the power transmitting unit 22. A method of the first output adjusting unit 24 for intermittently operating the inverter 21 may be a known method or a method that is developed in the future.

In addition, the first output adjusting unit 24 changes at least one of a length of the output period T1 and a length of the non-output period T2 in accordance with an operation from a user that has been received by the operation receiving unit 23. In accordance with this, the first output adjusting unit 24 can adjust a power value of the DC power output to the load LD by the toilet seat part 10 receiving an AC voltage through wireless power transmission. As will be described below, the reason for this is that a power value of the DC power output to the load LD by the toilet seat part 10 receiving an AC voltage through wireless power transmission is changed in accordance with a change in each of the length of the output period T1 and the length of the non-output period T2 in a case in which the first output adjusting unit 24 intermittently operates the inverter 21. Here, in the present disclosure, adjustment of the power value of the DC power output to the load LD by the toilet seat part 10 may be adjustment of a voltage value of a DC voltage output to the load LD by the toilet seat part 10, adjustment of a current value of a DC current output to the load LD by the toilet seat part 10, or adjustment of both the voltage value and the current value.

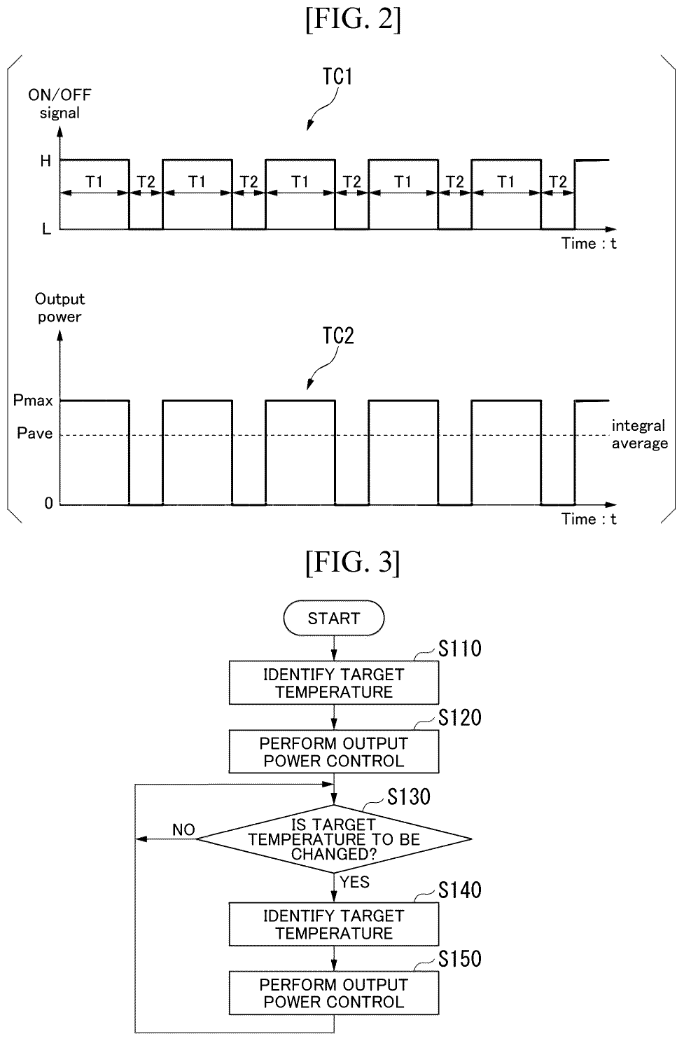

FIG. 2 is a diagram illustrating one example of timings at which the inverter 21 in operation starts an output period T1 and starts a non-output period T2. A graph TC1 illustrated in FIG. 2 is a timing diagram illustrating one example of timings at which the inverter 21 starts the output period T1 and starts the non-output period T2. A horizontal axis of the graph TC1 represents an elapsed time. A vertical axis of the graph TC1 represents a state of the inverter 21. More specifically, an item H on the vertical axis of the graph TC1 represents that the state of the inverter 21 is a state in which an AC voltage is output to the power transmitting unit 22. An item L on the vertical axis of the graph TC1 represents that the state of the inverter 21 is a state in which no AC voltage is output to the power transmitting unit 22.

In a case in which the inverter 21 alternately repeats the output period T1 and the non-output period T2 at timings represented by the graph TC1 illustrated in FIG. 2, a waveform representing a change in a power value of DC power over time, which is output to the load LD by the rectification circuit 12 of the toilet seat part 10, becomes the waveform represented in a graph TC2 illustrated in FIG. 2. In FIG. 2, a horizontal axis of the graph TC2 coincides with a horizontal axis of the graph TC1. In the output period T1, the rectification circuit 12 outputs DC power of which a power value is Pmax to the load LD. On the other hand, in the non-output period T2, the rectification circuit 12 does not output DC power to the load LD. For this reason, in a case in which the inverter 21 alternately repeats the output period T1 and the non-output period T2 at timings represented by the graph TC1 illustrated in FIG. 2, the rectification circuit 12 outputs DC power of which a power value is Pave lower than Pmax to the load LD. Here, in this case, Pave is an average value of the power value of the DC power output to the load LD per unit time by the rectification circuit 12. The longer the length of the non-output period T2, the lower the value Pave is. In addition, the shorter the length of the output period T1, the lower the value Pave is. Furthermore, the shorter the length of the non-output period T2, the higher the value Pave is. In addition, the longer the length of the output period T1, the higher the value Pave is. Here, a maximum value of Pave is Pmax.

In this way, in a case in which the first output adjusting unit 24 intermittently operates the inverter 21, the longer the output period T1 becomes, the more a power value of the DC power output to the load LD by the toilet seat part 10 receiving an AC voltage through wireless power transmission increases. In addition, in this case, the shorter the non-output period T2 becomes, the more this power value increases. On the other hand, in this case, the shorter the output period T1 becomes, the more this power value decreases. In addition, in this case, the longer the non-output period T2 becomes, the more this power value decreases. Thus, hereinafter, as one example, a case in which the first output adjusting unit 24 changes the length of the non-output period T2 in accordance with an operation from a user that has been received by the operation receiving unit 23 will be described. In this case, the length of the output period T1 is determined in advance.

For example, in a case in which an operation that has been received from a user by the operation receiving unit 23 is an operation of pressing the first button described above, the first output adjusting unit 24 sets the length of the non-output period T2 to a length associated with the first target temperature and intermittently operates the inverter 21. In accordance with this, by adjusting the DC power output to the load LD by the toilet seat part 10, the first output adjusting unit 24 can cause the temperature of the casing of the toilet seat part 10 to approach the first target temperature. Here, the length associated with the first target temperature is determined such that the temperature of the casing of the toilet seat part 10 becomes the first target temperature in accordance with the intermittent operation of the inverter 21 using an in-advance test, a simulation, or the like.

In addition, for example, in a case in which an operation that has been received from a user by the operation receiving unit 23 is an operation of pressing the second button described above, the first output adjusting unit 24 sets the length of the non-output period T2 to a length associated with the second target temperature and intermittently operates the inverter 21. In accordance with this, by adjusting the DC power output to the load LD by the toilet seat part 10, the first output adjusting unit 24 can cause the temperature of the casing of the toilet seat part 10 to approach the second target temperature. Here, the length associated with the second target temperature is determined such that the temperature of the casing of the toilet seat part 10 becomes the second target temperature in accordance with the intermittent operation of the inverter 21 using an in-advance test, a simulation, or the like.

In addition, for example, in a case in which an operation that has been received from a user by the operation receiving unit 23 is an operation of pressing the third button described above, the first output adjusting unit 24 sets the length of the non-output period T2 to a length associated with the third target temperature and intermittently operates the inverter 21. In accordance with this, by adjusting the DC power output to the load LD by the toilet seat part 10, the first output adjusting unit 24 can cause the temperature of the casing of the toilet seat part 10 to approach the third target temperature. Here, the length associated with the third target temperature is determined such that the temperature of the casing of the toilet seat part 10 becomes the third target temperature in accordance with the intermittent operation of the inverter 21 using an in-advance test, a simulation, or the like.

In addition, the first output adjusting unit 24 may be configured to include a storage unit that is not illustrated in the drawing or may be configured not to include a storage unit. In a case in which the first output adjusting unit 24 does not include a storage unit, the main body part 20 includes a storage unit separated from the first output adjusting unit 24. Hereinafter, as one example, a case in which the first output adjusting unit 24 includes a storage unit will be described. The storage unit included in the first output adjusting unit 24, for example, is a random access memory (RAM), a read only memory (ROM), or the like but is not limited to these.

### Process of Adjusting Power Value of DC Power Output to Load by Toilet Seat Part According to Embodiment

Hereinafter, the process of adjusting a power value of the DC power output to the load LD by the toilet seat part 10 according to the embodiment will be described with reference to FIG. 3. FIG. 3 is a diagram illustrating one example of a flow of the process of adjusting a power value of the DC power output to the load LD by the toilet seat part 10 according to the embodiment. Here, in the toilet seat device 1 according to the embodiment, the first output adjusting unit 24 of the main body part 20 performs the process of the flowchart illustrated in FIG. 3. In accordance with this, the toilet seat device 1 can adjust DC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part while inhibiting an increase in the number of components. In addition, hereinafter, as one example, a case in which after-start-up target temperature information representing a temperature determined in advance as a target temperature immediately after start-up of the main body part 20 is stored in a storage unit included in the first output adjusting unit 24 in advance will be described. The temperature represented by the after-start-up target temperature information is one of the first target temperature, the second target temperature, and the third target temperature. Hereinafter, as one example, a case in which first non-output period length information representing a length associated with the first target temperature is stored in the storage unit in advance as a length of the non-output period T2 will be described. In addition, hereinafter, as one example, a case in which second non-output period length information representing a length associated with the second target temperature is stored in the storage unit in advance as a length of the non-output period T2 will be described. Furthermore, hereinafter, as one example, a case in which third non-output period length information representing a length associated with the third target temperature is stored in the storage unit in advance as a length of the non-output period T2 will be described. The main body part 20 continuously performs the process of the flowchart illustrated in FIG. 3 in a period until power supply to the main body part 20 stops after the main body part 20 starts up.

After the main body part 20 starts up, the first output adjusting unit 24 of the main body part 20 reads after-start-up target temperature information from the storage unit included in the first output adjusting unit 24 and identifies a temperature represented by the read after-start-up target temperature information as a target temperature (Step S110).

Next, the first output adjusting unit 24 performs control of the inverter 21 to output an AC voltage having a voltage value associated with the target temperature identified in Step S110 to the power transmitting unit 22 (Step S120). In FIG. 3, the process of Step S120 is represented as “PERFORM OUTPUT POWER CONTROL.” More specifically, for example, in a case in which this target temperature is the first target temperature, the first output adjusting unit 24 reads first non-output period length information associated with the first target temperature from the storage unit included in the first output adjusting unit 24. Then, the first output adjusting unit 24 sets the length of the non-output period T2 to a length represented by the read first non-output period length information and intermittently operates the inverter 21. In addition, for example, in a case in which this target temperature is the second target temperature, the first output adjusting unit 24 reads second non-output period length information associated with the second target temperature from the storage unit included in the first output adjusting unit 24. Then, the first output adjusting unit 24 sets the length of the non-output period T2 to a length represented by the read second non-output period length information and intermittently operates the inverter 21. In addition, in a case in which this target temperature is the third target temperature, the first output adjusting unit 24 reads third non-output period length information associated with the third target temperature from the storage unit included in the first output adjusting unit 24. Then, the first output adjusting unit 24 sets the length of the non-output period T2 to a length represented by the read third non-output period length information and intermittently operates the inverter 21. In accordance with this, the first output adjusting unit 24 can cause the temperature of the casing of the toilet seat part 10 to approach the target temperature identified in Step S110 without using wireless communication between the toilet seat part 10 and the main body part 20.

Next, the first output adjusting unit 24 determines whether or not the target temperature is to be changed (Step S130). In a case in which an operation of changing the target temperature has been received by the operation receiving unit 23, the first output adjusting unit 24 determines that the target temperature is to be changed in Step

S130. On the other hand, in a case in which an operation of changing the target temperature has not been received by the operation receiving unit 23, the first output adjusting unit 24 determines that the target temperature is not to be changed in Step S130. For example, in a case in which the current target temperature is the second target temperature, even when an operation of pressing the second button is received by the operation receiving unit 23, the first output adjusting unit 24 determines that the operation of changing the target temperature has not been received by the operation receiving unit 23. On the other hand, for example, in a case in which the current target temperature is the second target temperature, when an operation of pressing the first button or the third button is received by the operation receiving unit 23, the first output adjusting unit 24 determines that an operation of changing the target temperature has been received by the operation receiving unit 23. In other words, in a case in which an operation of pressing a button different from a button associated with the current target temperature has been received, the first output adjusting unit 24 determines that an operation of changing the target temperature has been received by the operation receiving unit 23.

In a case in which it is determined that the target temperature is not to be changed in Step S130 (Step S130—No), the first output adjusting unit 24 causes the process to proceed to Step S130 without performing any process and determines whether or not the target temperature is to be changed again.

On the other hand, in a case in which it is determined that the target temperature is to be changed in Step S130 (Step S130—Yes), the first output adjusting unit 24 identifies the target temperature in accordance with an operation received by the operation receiving unit 23 in Step S130 (Step S140). For example, in a case in which the operation that has been received by the operation receiving unit 23 in Step S130 is an operation of pressing the first button, the first output adjusting unit 24 identifies that the target temperature is the first target temperature in Step S140. In addition, for example, in a case in which the operation that has been received by the operation receiving unit 23 in Step S130 is an operation of pressing the second button, the first output adjusting unit 24 identifies that the target temperature is the second target temperature in Step S140. Furthermore, for example, in a case in which the operation that has been received by the operation receiving unit 23 in Step S130 is an operation of pressing the third button, the first output adjusting unit 24 identifies that the target temperature is the third target temperature in Step S140.

Next, the first output adjusting unit 24 performs control of the inverter 21 to output an AC voltage having a voltage value associated with the target temperature identified in Step S140 to the power transmitting unit 22 (Step S150). In FIG. 3, the process of Step S150 is represented as “PERFORM OUTPUT POWER CONTROL.” More specifically, the first output adjusting unit 24 intermittently operates the inverter 21 to output the AC voltage having this voltage value to the power transmitting unit 22 in Step S150. The process of Step S150 is similar to the process of Step S120. For this reason, in the present disclosure, description of the process of Step S150 will be omitted.

After control of the inverter 21 using the first output adjusting unit 24 is started in Step S150, the first output adjusting unit 24 causes the process to proceed to Step S130 and determines whether or not the target temperature is to be changed again.

As described above, the toilet seat device 1 according to the embodiment is a toilet seat device that includes the toilet seat part 10 and the main body part 20 to which the toilet seat part 10 is detachably attached, the main body part 20 transmits electric power to the toilet seat part 10 through wireless power transmission, the toilet seat part 10 receives electric power from the main body part 20 through wireless power transmission, and includes the load LD to which electric power received from the main body part 20 is supplied, and the main body part 20 adjusts a power value of the electric power output to the load LD by the toilet seat part 10 without using wireless communication between the toilet seat part 10 and the main body part 20. More specifically, in the toilet seat device 1, the main body part 20 includes the first output adjusting unit 24 that adjusts this power value, the inverter 21 that converts a DC voltage supplied from a power supply P into an AC voltage, and the power transmitting unit 22 that transmits the AC voltage supplied from the inverter 21 to the toilet seat part 10. The inverter 21 outputs the AC voltage after conversion to the power transmitting unit 22, and the first output adjusting unit 24 adjusts the power value by controlling inverter 21 in accordance with a received operation. In accordance with this, the toilet seat device 1 can adjust a power value of the electric power output to the load LD by the toilet seat part 10 without including a member related to wireless communication between the toilet seat part 10 and the main body part 20. As a result, the toilet seat device 1 can control electric power supplied to the load LD included in the toilet seat part 10 that can be detached from the main body part 20 while inhibiting an increase in the number of components. In addition, since the toilet seat device 1 can inhibit an increase in the number of components, an increase in the manufacturing cost can be inhibited as well. Furthermore, since the toilet seat device 1 may not perform wireless communication between the toilet seat part 10 and the main body part 20, noise via wireless communication is not generated. As a result, the toilet seat device 1 can inhibit occurrence of a defective operation due to noise.

In addition, in a case in which a load to which an AC voltage received from the main body part 20 is supplied is the load LD, the first output adjusting unit 24 can adjust a power value of the AC power output to the load LD by the toilet seat part 10 by changing at least one of the length of the output period T1 and the length of the non-output period T2. In other words, in this case, the first output adjusting unit 24 can adjust a power value of the AC power output to the load LD by the toilet seat part 10 by performing the process of the flowchart illustrated in FIG. 3. In addition, also in a case in which a load driven using an AC voltage received from the main body part 20 is the load LD, the first output adjusting unit 24 can adjust a power value of the AC power output to the load LD by the toilet seat part 10 by changing at least one of the length of the output period T1 and the length of the non-output period T2. In other words, also in this case, the first output adjusting unit 24 can adjust a power value of the AC power output to the load LD by the toilet seat part 10 by performing the process of the flowchart illustrated in FIG. 3.

### Modified Example 1 of Embodiment

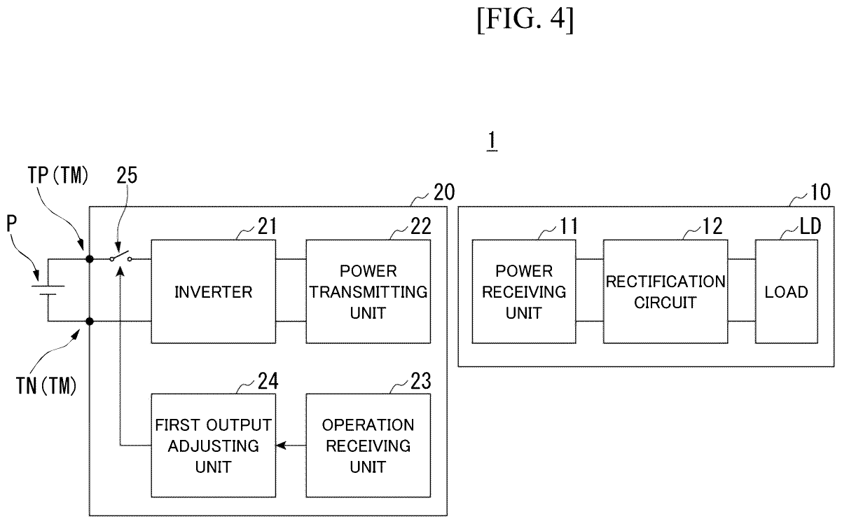

Hereinafter, Modified Example 1 of the embodiment will be described. FIG. 4 is a diagram illustrating one example of the configuration of a toilet seat device 1 according to Modified Example 1 of the embodiment. As illustrated in FIG. 4, a main body part 20 of the toilet seat device 1 may be configured to include a switch 25 in addition to a power supply terminal TM, an inverter 21, and a power transmitting unit 22.

The switch 25 performs switching of a conduction state between the power supply terminal TM and the inverter 21 in accordance with control using the first output adjusting unit 24. The switch 25, for example, is a field effect transistor or the like but is not limited thereto. In the example illustrated in FIG. 4, the switch 25 is connected between a positive electrode-side power supply terminal TP of the power supply terminal TM and a positive electrode-side power supply terminal among power supply terminals, which are not illustrated, included in the inverter 21.

In a case in which the main body part 20 includes the switch 25, the first output adjusting unit 24 intermittently operates the inverter 21 not by directly controlling the inverter 21 but by controlling the switch 25. Also in accordance with this, the first output adjusting unit 24 can change at least one of the length of the output period T1 and the length of the non-output period T2. In other words, also in this case, the toilet seat device 1 can adjust a power value of the electric power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components. In addition, since the toilet seat device 1 can inhibit an increase in the number of components, an increase in the manufacturing cost can be inhibited as well. Furthermore, since the toilet seat device 1 may not perform wireless communication between the toilet seat part 10 and the main body part 20, noise via wireless communication is not generated. As a result, the toilet seat device 1 can inhibit occurrence of a defective operation due to noise.

### Modified Example 2 of Embodiment

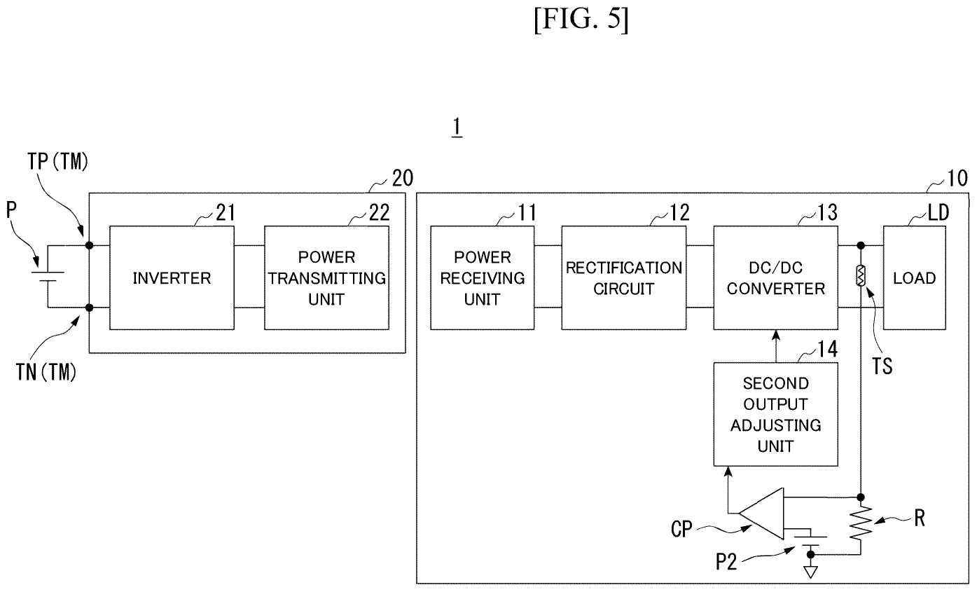

Hereinafter, Modified Example 2 of the embodiment will be described. FIG. 5 is a diagram illustrating one example of the configuration of a toilet seat device 1 according to Modified Example 2 of the embodiment.

In Modified Example 2 of the embodiment, a main body part 20 of the toilet seat device 1, as illustrated in FIG. 5, includes a power supply terminal TM, an inverter 21, and a power transmitting unit 22 without including the first output adjusting unit 24 and the operation receiving unit 23. In Modified Example 2 of the embodiment, the toilet seat part 10 of the toilet seat device 1, as illustrated in FIG. 5, includes a DC/DC converter 13, a thermistor TS, a resistance element R, a power supply P2, a comparator CP, and a second output adjusting unit 14 in addition to a power receiving unit 11 and a rectification circuit 12.

The DC/DC converter 13 transforms a DC voltage supplied from the rectification circuit 12 into a DC voltage having a voltage value determined in advance. The DC/DC converter 13 outputs the DC voltage after transformation to a load LD. In accordance with this, the DC/DC converter 13 outputs DC power to the load LD.

The thermistor TS is a thermistor used for detecting a temperature of the casing of the toilet seat part 10. For this reason, the thermistor TS is mounted in the casing, which is not illustrated, of the toilet seat part 10. A temperature characteristic of the thermistor TS may be either a negative temperature coefficient (NTC) or a positive temperature coefficient (PTC). Hereinafter, as one example, a case in which the temperature characteristic of the thermistor TS is the NTC will be described.

One of two terminals included in the thermistor TS is connected to a positive electrode-side transmission line out of two transmission lines connecting the DC/DC converter 13 and the load LD to each other. In addition, the other of the two terminals included in the thermistor TS is connected to one out of two terminals included in the resistance element R. The other of the two terminals included in the resistance element R is grounded to ground.

In addition, the other of the two terminals included in the resistance element R is further connected to one of two input terminals included in the comparator CP. One of the two input terminals may be either an inverting input terminal or a non-inverting input terminal. In addition, the other of the two input terminals included in the comparator CP is connected to a positive electrode-side power supply terminal of a power supply P2 that is a DC power supply. In addition, a negative electrode-side power supply terminal of the power supply P2 is grounded to ground and is connected to the other of the two terminals included in the resistance element R. An output terminal of the comparator CP is connected to the second output adjusting unit 14. Hereinafter, for the convenience of description, a voltage value of a voltage input to one of two input terminals included in the comparator CP, that is, a voltage value of a DC voltage divided in accordance with the thermistor TS and the resistance element R will be referred to as a target voltage value in description.

In addition, the power supply P2 may be any power supply as long as it is a DC power supply that generates a reference voltage of the comparator CP. Here, a voltage value of the reference voltage generated by the power supply P2, for example, is a voltage value coinciding with a target voltage value of a case in which the temperature of the casing of the toilet seat part 10 is a lower limit temperature determined in advance. In addition, the voltage value of the reference voltage generated by the power supply P2 may be a voltage value lower than the target voltage value of this case or may be a voltage value higher than the target voltage value of this case.

Here, in a case in which the target voltage value is the voltage value of the reference voltage generated by the power supply P2 or more, for example, the comparator CP outputs a signal of which a signal level is an L level from an output terminal to the second output adjusting unit 14. On the other hand, in a case in which the target voltage value is less than the voltage value of the reference voltage generated by the power supply P2, for example, the comparator CP outputs a signal of which a signal level is an H level from the output terminal to the second output adjusting unit 14. In accordance with this, the second output adjusting unit 14 can determine whether or not the temperature of the casing of the toilet seat part 10 exceeds the lower limit temperature described above in accordance with a change of the resistance value of the thermistor TS.

The second output adjusting unit 14 determines whether or not the temperature of the casing of the toilet seat part 10 exceeds the lower limit temperature based on a signal supplied from the comparator CP. In a case in which the target voltage value is the voltage value of the reference voltage or more, the second output adjusting unit 14 determines that the temperature of the casing of the toilet seat part 10 is the lower limit temperature or higher. In a case in which it is determined that the temperature of the casing of the toilet seat part 10 is the lower limit temperature or higher, for example, the second output adjusting unit 14 does not perform any process. On the other hand, in a case in which the target voltage value is less than the voltage value of the reference voltage, the second output adjusting unit 14 determines that the temperature of the casing of the toilet seat part 10 is lower than the lower limit temperature. In a case in which it is determined that the temperature of the casing of the toilet seat part 10 is lower than the lower limit temperature, the second output adjusting unit 14, for example, increases a power value of the DC power output from the DC/DC converter 13 to the load LD by controlling the DC/DC converter 13. In other words, in this case, the second output adjusting unit 14 adjusts the power value of the DC power output from the DC/DC converter 13 to the load LD to raise the temperature of the casing of the toilet seat part 10. In this way, the toilet seat device 1 can adjust a power value of the DC power output to the load LD by the toilet seat part 10 without including a member related to wireless communication between the toilet seat part 10 and the main body part 20. As a result, the toilet seat device 1 can control electric power supplied to the load LD included in the toilet seat part 10 that can be detached from the main body part 20 while inhibiting an increase in the number of components.

### Process of Adjusting Power Value of DC Power Output to Load by Toilet Seat Part According to Modified Example 1 of Embodiment

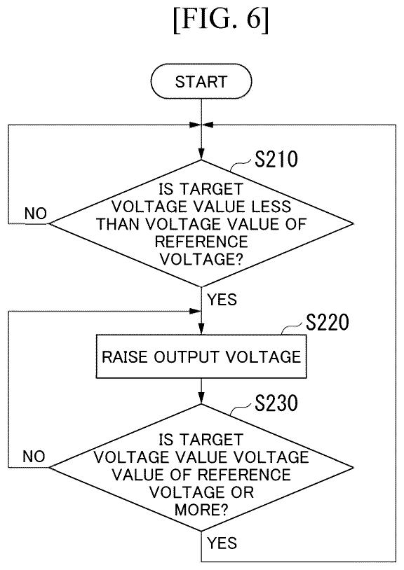

Hereinafter, a process of adjusting a power value of the DC power output to the load LD by the toilet seat part 10 according to Modified Example 1 of the embodiment will be described with reference to FIG. 6. FIG. 6 is a diagram illustrating one example of a flow of the process of adjusting a power value of the DC power output to the load LD by the toilet seat part 10 according to Modified Example 1 of the embodiment. Here, in the toilet seat device 1 according to Modified Example 1 of the embodiment, the second output adjusting unit 14 of the toilet seat part 10 performs the process of the flowchart illustrated in FIG. 6. In accordance with this, the toilet seat device 1 can adjust a power value of the DC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part while inhibiting an increase in the number of components. In a period until power supply from the main body part 20 to the toilet seat part 10 stops after power supply from the main body part 20 to the toilet seat part 10 starts, the toilet seat part 10 continuously performs the process of the flowchart illustrated in FIG. 6.

After power supply from the main body part 20 to the toilet seat part 10 starts, the second output adjusting unit 14 determines whether or not the target voltage value is less than a voltage value of the reference voltage based on a signal supplied from the comparator CP (Step S210). In addition, the process of Step S210 may be rephrased as a process in which the second output adjusting unit 14 determines whether or not the temperature of the casing of the toilet seat part 10 is lower than the lower limit temperature. In FIG. 6, the process of Step S210 is represented as “IS TARGET VOLTAGE VALUE LESS THAN VOLTAGE VALUE OF REFERENCE VOLTAGE?.”

In a case in which it is determined that the target voltage value is the voltage value of the reference voltage or more (Step S210—No), the second output adjusting unit 14 causes the process to proceed to Step S210 and determines whether or not the target voltage value is less than the voltage value of the reference voltage again based on a signal supplied from the comparator CP.

On the other hand, in a case in which it is determined that the target voltage value is less than the voltage value of the reference voltage (Step S210—Yes), the second output adjusting unit 14 controls the DC/DC converter 13, for example, to raise the voltage value of the DC voltage output by the DC/DC converter 13 by a unit increment value determined in advance (Step S220). In accordance with this, the second output adjusting unit 14 can raise a power value of the DC power output to the load LD by the toilet seat part 10, in other words, can adjust a power value of the DC power output to the load LD by the toilet seat part 10. In addition, the unit increment value may be any value as long as it is a value that can raise the output voltage of the DC/DC converter 13 a plurality of number of times.

Next, the second output adjusting unit 14 determines whether or not the target voltage value is the voltage value of the reference voltage or more based on a signal supplied from the comparator CP (Step S230). In addition, the process of Step S230 may be paraphrased as a process in which the second output adjusting unit 14 determines whether or not the temperature of the casing of the toilet seat part 10 is the lower limit temperature or higher. In FIG. 6, the process of Step S230 is represented as “IS TARGET VOLTAGE VALUE VOLTAGE VALUE OF REFERENCE VOLTAGE OR MORE?”

In a case in which it is determined that the target voltage value is less than the voltage value of the reference voltage (Step S230—No), the second output adjusting unit 14 causes the process to proceed to Step S220 and performs control of the DC/DC converter 13, for example, to raise the output voltage of the DC/DC converter 13 by a unit increment value determined in advance again. In addition, in Step S220, in a case in which the voltage value of the DC voltage output by the DC/DC converter 13 has reached a maximum value, the second output adjusting unit 14, for example, may perform an operation of sounding a buzzer indicating error after stopping the operation of the DC/DC converter 13, turning on light indicating error after stopping the operation of the DC/DC converter 13, or the like or may not perform any operation.

On the other hand, in a case in which it is determined that the target voltage value is the voltage value of the reference voltage or more (Step S230—Yes), the second output adjusting unit 14 causes the process to proceed to Step S210 and determines whether or not the target voltage value is less than the voltage value of the reference voltage again based on a signal supplied from the comparator CP. The reason for this is that, in this case, the temperature of the casing of the toilet seat part 10 is assumed to has returned to be the lower limit temperature or higher.

As described above, the toilet seat device 1 according to Modified Example 2 of the embodiment is a toilet seat device that includes the toilet seat part 10 and the main body part 20 to which the toilet seat part 10 is detachably attached, the main body part 20 transmits an AC voltage to the toilet seat part 10 through wireless power transmission, the toilet seat part 10 receives an AC voltage from the main body part 20 through wireless power transmission and includes the load LD to which a DC voltage according to the AC voltage received from the main body part 20 is supplied, and the toilet seat part 10 adjusts a power value of the DC power output to the load LD by the toilet seat part 10 without using wireless communication between toilet seat part 10 and the main body part 20. More specifically, in the toilet seat device 1, the toilet seat part 10 includes the second output adjusting unit 14 that adjusts a power value of the DC power output to the load LD by the toilet seat part 10, the power receiving unit 11 that receives an AC voltage from the main body part 20 through wireless power transmission, the rectification circuit 12 that converts the AC voltage received by the power receiving unit 11 into a DC voltage, the DC/DC converter 13 that transforms a DC voltage supplied from the rectification circuit 12, and the thermistor TS that is connected between the DC/DC converter 13 and the load LD. The DC/DC converter 13 outputs a DC voltage after transformation to the load LD, and the second output adjusting unit 14 performs control of the DC/DC converter 13 based on a voltage signal output from the thermistor TS and adjusts a power value of the DC power output to the load LD by the toilet seat part 10. In accordance with this, the toilet seat device 1 can adjust a power value of the DC power output to the load LD by the toilet seat part 10 without including a member related to wireless communication between the toilet seat part 10 and the main body part 20. As a result, the toilet seat device 1 can control electric power supplied to the load LD included in the toilet seat part 10 that can be detached from the main body part while inhibiting an increase in the number of components. In addition, the toilet seat device 1 according to Modified Example 2 of the embodiment can close signal processing of the thermistor TS in the toilet seat part 10. For this reason, in the toilet seat device 1, the toilet seat part 10 can be detached from the main body part 20, and high-speed control can be realized.

In addition, the configuration in which the toilet seat part 10 outputs a signal representing whether or not the temperature of the casing of the toilet seat part 10 is less than the lower limit temperature in accordance with a voltage signal output from the thermistor TS may be another configuration in which this signal can be output in accordance with this voltage signal instead of the configuration illustrated in FIG. 5.

### Modified Example 3 of Embodiment

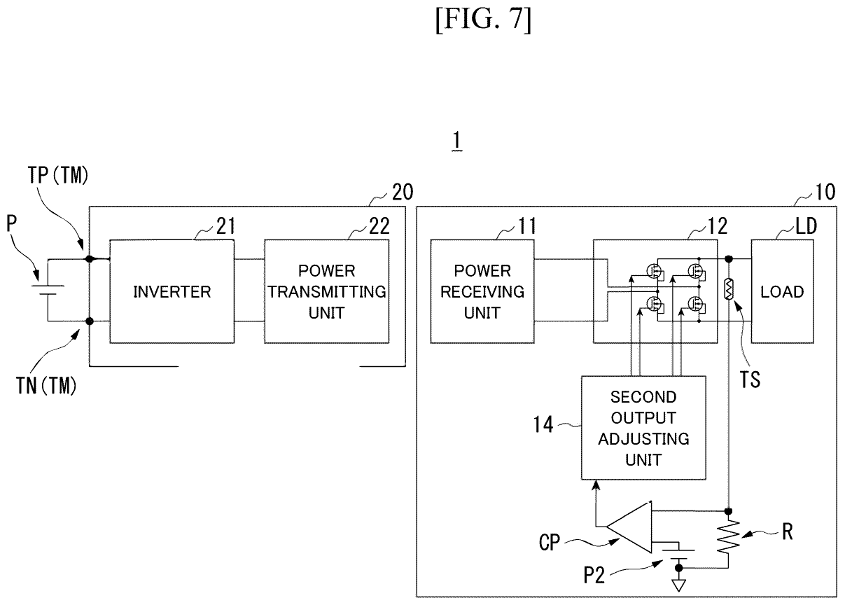

Hereinafter, Modified Example 3 of the embodiment will be described. Modified Example 3 of the embodiment is a modified example of Modified Example 2 of the embodiment. FIG. 7 is a diagram illustrating one example of the configuration of a toilet seat device 1 according to Modified Example 3 of the embodiment. A toilet seat part 10 of the toilet seat device 1 according to Modified Example 3 of the embodiment, as illustrated in FIG. 7, may have a configuration in which a power receiving unit 11, a rectification circuit 12, a second output adjusting unit 14, a load LD, a thermistor TS, a resistance element R, a comparator CP, and a power supply P2 are included, and the DC/DC converter 13 is not included. Here, in the toilet seat part 10 according to Modified Example 3 of the embodiment, the rectification circuit 12, as illustrated in FIG. 7, may be a Metal Oxide Semiconductor Field Effect Transistor (MOSFET) rectifier. In this case, the rectification circuit 12 includes four MOSFETs. These four MOSFETs represent one example of four switching elements included in the rectification circuit 12. In other words, in this case, the rectification circuit 12 converts an AC voltage received by the power receiving unit 11 into a DC voltage through switching of these four MOSFETs and outputs the DC voltage after conversion to the load LD. In this case, by controlling the four MOSFETs included in the rectification circuit 12 instead of the DC/DC converter 13, the second output adjusting unit 14 adjusts a power value of the DC power output to the load LD by the rectification circuit 12. Also in this case, the toilet seat device 1 can adjust a power value of the DC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components. In addition, the toilet seat device 1 according to Modified Example 3 of the embodiment can close signal processing of the thermistor TS in the toilet seat part 10. For this reason, in the toilet seat device 1, the toilet seat part 10 can be detached from the main body part 20, and high-speed control can be realized. Furthermore, in the toilet seat device 1 according to Modified Example 3 of the embodiment, the toilet seat part 10 does not need to include the DC/DC converter 13. This leads to simplification of design of the toilet seat device 1 and inhibition of an increase in the manufacturing cost of the toilet seat device 1, which is significant.

In addition, in Modified Example 3 of the embodiment, at least one of the four MOSFETs may be replaced with other switching elements such as bipolar transistors.

### Modified Example 4 of Embodiment

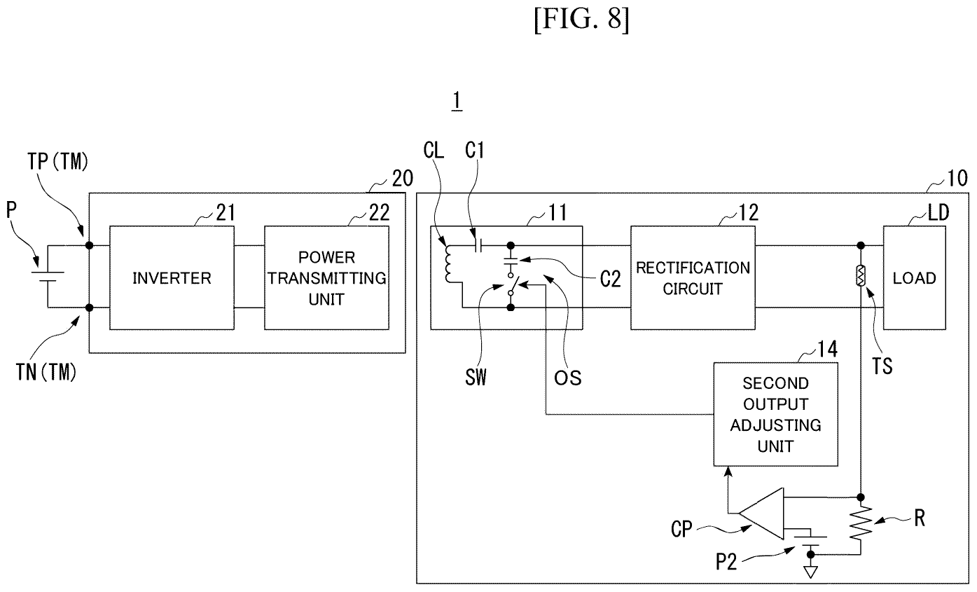

Hereinafter, Modified Example 4 of the embodiment will be described. Modified Example 4 of the embodiment is a modified example of Modified Example 2 of the embodiment. FIG. 8 is a diagram illustrating one example of the configuration of a toilet seat device 1 according to Modified Example 4 of the embodiment. A toilet seat part 10 of the toilet seat device 1 according to Modified Example 4 of the embodiment, as illustrated in FIG. 8, may have a configuration in which a power receiving unit 11, a rectification circuit 12, a second output adjusting unit 14, a load LD, a thermistor TS, a resistance element R, a comparator CP, and a power supply P2 are included, and the DC/DC converter 13 is not included. Here, in the toilet seat part 10 according to Modified Example 4 of the embodiment, as illustrated in FIG. 8, the power receiving unit 11 is configured to include a power reception-side resonant circuit OS and a switching element SW that changes the resonance frequency of the power reception-side resonant circuit OS.

The power reception-side resonant circuit OS is configured to include a power receiving coil CL and capacitors C1 and C2.

The power receiving coil CL is one example of the power receiving coil described in the embodiment.

The switching element SW, for example, is a field effect transistor, a bipolar transistor, or the like but is not limited thereto. Hereinafter, as one example, a case in which the switching element SW is a field effect transistor will be described.

In the example illustrated in FIG. 8, one of two terminals included in the power receiving coil CL is connected to one of two terminals included in the capacitor C1. In addition, in this example, the other of the two terminals included in the capacitor C1 is connected to each of one of two input terminals included in the rectification circuit 12 and one of two terminals included in the capacitor C2. Furthermore, in this example, the other of the two terminals included in the capacitor C2 is connected to a drain terminal of the switching element SW. In addition, in this example, a source terminal of the switching element SW is connected to each of the other of the two terminals included in the power receiving coil CL and the other of the two input terminals included in the rectification circuit 12. A gate terminal of the switching element SW is connected to the second output adjusting unit 14.

In this case, by controlling the switching element SW, the second output adjusting unit 14 can adjust the DC power output to the load LD by the toilet seat part 10 by changing the resonance frequency of the power reception-side resonant circuit OS. In other words, also in this case, the toilet seat device 1 can adjust a power value of the DC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components. In addition, the toilet seat device 1 according to Modified Example 4 of the embodiment can close signal processing of the thermistor TS in the toilet seat part 10. For this reason, in the toilet seat device 1, the toilet seat part 10 can be detached from the main body part 20, and high-speed control can be realized. Furthermore, in the toilet seat device 1 according to Modified Example 4 of the embodiment, the toilet seat part 10 does not need to include the DC/DC converter 13. This leads to simplification of design of the toilet seat device 1 and inhibition of an increase in the manufacturing cost of the toilet seat device 1, which is significant.

In addition, in Modified Example 4 of the embodiment, in a case in which a load to which an AC voltage received from the main body part 20 is supplied is the load LD, the toilet seat part 10, for example, includes a temperature detecting unit detecting the temperature of the casing of the toilet seat part 10 in place of the thermistor TS, the resistance element R, the comparator CP, and the power supply P2. In this case, the second output adjusting unit 14 controls the switching element SW based on a signal representing the temperature detected by the temperature detecting unit. In accordance with this, the second output adjusting unit 14 can adjust an AC power output to the load LD by the toilet seat part 10 by changing the resonance frequency of the power reception-side resonant circuit OS. In other words, in this case, the toilet seat device 1 can adjust a power value of the AC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components. In addition, in Modified Example 4 of the embodiment, also in a case in which a load driven using an AC voltage received from the main body part 20 is the load LD, the toilet seat part 10, for example, includes a temperature detecting unit detecting the temperature of the casing of the toilet seat part 10 in place of the thermistor TS, the resistance element R, the comparator CP, and the power supply P2. Also in this case, the second output adjusting unit 14 controls the switching element SW based on a signal representing the temperature detected by the temperature detecting unit. In accordance with this, the second output adjusting unit 14 can adjust an AC power output to the load LD by the toilet seat part 10 by changing the resonance frequency of the power reception-side resonant circuit OS. In other words, also in this case, the toilet seat device 1 can adjust a power value of the AC power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components.

### Modified Example 5 of Embodiment

Each of the embodiment described above and Modified Example 1 of the embodiment and each of Modified Example 2 of the embodiment, Modified Example 3 of the embodiment, and Modified Example 4 of the embodiment may be combined in any form. For example, the toilet seat device 1 according to Modified Example 5 of the embodiment may include the toilet seat part 10 according to Modified Example 2 of the embodiment and the main body part 20 according to the embodiment. In addition, for example, the toilet seat device 1 according to Modified Example 5 of the embodiment may include the toilet seat part 10 according to Modified Example 2 of the embodiment and the main body part 20 according to Modified Example 1 of the embodiment. Furthermore, for example, the toilet seat device 1 according to Modified Example 5 of the embodiment may include the toilet seat part 10 according to Modified Example 3 of the embodiment and the main body part 20 according to the embodiment. In addition, for example, the toilet seat device 1 according to Modified Example 5 of the embodiment may include the toilet seat part 10 according to Modified Example 3 of the embodiment and the main body part 20 according to Modified Example 1 of the embodiment. Furthermore, for example, the toilet seat device 1 according to Modified Example 5 of the embodiment may include the toilet seat part 10 according to Modified Example 4 of the embodiment and the main body part 20 according to the embodiment. In addition, for example, the toilet seat device 1 according to Modified Example 5 of the embodiment may include the toilet seat part 10 according to Modified Example 4 of the embodiment and the main body part 20 according to Modified Example 1 of the embodiment. In any one of such cases, the toilet seat device 1 according to Modified Example 5 of the embodiment can adjust a power value of the electric power output to the load LD by the toilet seat part 10 without including a member related to wireless communication between the toilet seat part 10 and the main body part 20. As a result, the toilet seat device 1 can control the electric power supplied to the load LD included in the toilet seat part 10 that can be detached from the main body part 20 while inhibiting an increase in the number of components. The toilet seat device 1 can acquire effects acquired by combining the embodiment and each of such modified examples.

### Modified Example 6 of Embodiment

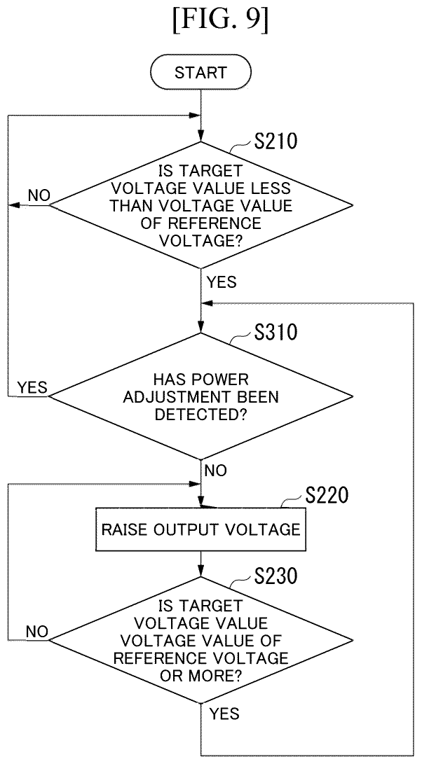

Hereinafter, Modified Example 6 of the embodiment will be described. Modified Example 6 of the embodiment is a modified example of Modified Example 5 of the embodiment. Hereinafter, as one example, a case in which the configuration of a main body part 20 according to Modified Example 6 of the embodiment is the configuration of the main body part 20 illustrated in FIG. 1, and the configuration of a toilet seat part 10 according to Modified Example 6 of the embodiment is the configuration of the toilet seat part 10 illustrated in FIG. 5 will be described. In the second output adjusting unit 14 according to Modified Example 5 of the embodiment, there are cases in which the power value of the DC power is adjusted by the second output adjusting unit 14 during adjustment of the power value of the DC power using the first output adjusting unit 24. Thus, the second output adjusting unit 14 according to Modified Example 6 of the embodiment may be configured to perform the process of a flowchart illustrated in FIG. 9 and not to perform adjustment of the power value of the DC power during adjustment of DC power using the first output adjusting unit 24. FIG. 9 is a diagram illustrating one example of a flow of the process of adjusting DC power output to a load LD by a toilet seat part 10 according to Modified Example 6 of the embodiment. The toilet seat part 10 continuously performs the process of the flowchart illustrated in FIG. 9 in a period until power supply from the main body part 20 to the toilet seat part 10 stops after the power supply from the main body part 20 to the toilet seat part 10 starts. In addition, while the process of the flowchart illustrated in FIG. 9 is performed by the second output adjusting unit 14 of the toilet seat part 10, the first output adjusting unit 24 of the main body part 20 continuously performs the process of the flowchart illustrated in FIG. 3. In Modified Example 6 of the embodiment, as one example, a case in which the second output adjusting unit 14 includes a voltage detecting unit, which is not illustrated, detecting a voltage value of a DC voltage output from the DC/DC converter 13 to the load LD will be described. In addition, this voltage detecting unit may be separated from the second output adjusting unit 14. In this case, the toilet seat part 10 includes the voltage detecting unit separately from the second output adjusting unit 14. The process of each of Steps S210, S220, and S230 illustrated in FIG. 9 is the same as the process of each of Steps S210, S220, and S230 (in no particular order) illustrated in FIG. 6. For this reason, description of the process of each of Steps S210, S220, and S230 is omitted in FIG. 9.

In a case in which it is determined that the target voltage value is the voltage value of the reference voltage or more (Step S210—Yes), the second output adjusting unit 14 determines whether or not adjustment of the power value of the DC power using the first output adjusting unit 24 of the main body part 20 has been performed (Step S310). In FIG. 9, the process of Step S310 is represented as “HAS POWER ADJUSTMENT BEEN DETECTED?”. For example, the second output adjusting unit 14 determines whether or not a variation width of a voltage value detected by a voltage detecting unit included in the second output adjusting unit 14 is a threshold TH1 determined in advance or more in Step S310. In a case in which it is determined that this variation width is the threshold TH1 or more, the second output adjusting unit 14 determines that adjustment of the power value of the DC power using the first output adjusting unit 24 of the main body part 20 has been performed. On the other hand, in a case in which it is determined that this variation width is less than the threshold TH1, the second output adjusting unit 14 determines that adjustment of the power value of the DC power using the first output adjusting unit 24 of the main body part 20 has not been performed. Here, the threshold TH1, for example, is a smallest variation width among variation widths of a voltage value detected by the voltage detecting unit in a case in which adjustment of the power value of the DC power using the first output adjusting unit 24 of the main body part 20 is performed. Such a threshold TH1 is determined using an in-advance test, a simulation, or the like. In addition, the threshold TH1 may be either a value larger than this smallest variation width or a value smaller than this smallest variation width.

In a case in which it is determined that adjustment of the power value of the DC power using the first output adjusting unit 24 of the main body part 20 has been performed (Step S310—Yes), the second output adjusting unit 14 causes the process to proceed to Step S210 and determines whether or not the target voltage value is the voltage value of the reference voltage or more based on a signal supplied from the comparator CP again. In accordance with this, the second output adjusting unit 14 can inhibit blocking of adjustment of the power value of the DC power using the first output adjusting unit 24 of the main body part 20.

On the other hand, in a case in which it is determined that adjustment of the power value of the DC power using the first output adjusting unit 24 of the main body part 20 has not been performed (Step S310—No), the second output adjusting unit 14 causes the process to proceed to Step S220 and raises the voltage value of the DC voltage output from the DC/DC converter 13 to the load LD by a unit increment value determined in advance. In accordance with this, in a case in which adjustment of the power value of the DC power using the first output adjusting unit 24 has not been performed, the second output adjusting unit 14 can adjust the power value of the DC power output from the DC/DC converter 13 to the load LD.

As above, the second output adjusting unit 14 can detect that adjustment of the power value of the DC power using the first output adjusting unit 24 has been performed and does not perform adjustment of the power value of the DC power based on a voltage signal output from the thermistor TS in a case in which it is detected that adjustment of the power value of the DC power using the first output adjusting unit 24 has been performed. In accordance with this, the toilet seat device 1 can adjust the power value of the DC power output from the DC/DC converter 13 to the load LD while inhibiting blocking of adjustment of the power value of the DC power using the first output adjusting unit 24 of the main body part 20.

In addition, in Modified Example 6 of the embodiment, the method for the second output adjusting unit 14 to detect that adjustment of the power value of the DC power using the first output adjusting unit 24 has been performed may be another method capable of detecting an intermittent operation of the inverter 21. In such a meaning, the configuration of the second output adjusting unit 14 according to Modified Example 6 of the embodiment can be paraphrased as a configuration in which the intermittent operation of the inverter 21 can be detected, and adjustment of the power value of the DC power based on a voltage signal output from the thermistor TS is not performed in a case in which an intermittent operation of the inverter 21 has been detected.

In addition, in Modified Example 6 of the embodiment, in a case in which the toilet seat part 10 does not include the DC/DC converter 13 as illustrated in FIGS. 7 and 8 and the like, the second output adjusting unit 14 controls the rectification circuit 12 in Step S220 illustrated in FIG. 9. In this case, the second output adjusting unit 14 includes a voltage detecting unit, which is not illustrated, detecting a voltage value of the DC voltage output from the rectification circuit 12 to the load LD in place of a voltage detecting unit, which is not illustrated, detecting a voltage value of the DC voltage output from the DC/DC converter 13 to the load LD. The second output adjusting unit 14 determines whether or not a variation width of the voltage value detected by this voltage detecting unit is the threshold TH1 determined in advance or more in Step S310.

In addition, the process of the flowchart illustrated in FIG. 9 may be a process performed by the second output adjusting unit 14 in a case in which each of the first output adjusting unit 24 and the second output adjusting unit 14 adjusts the power value of the AC power output to the load LD by the toilet seat part 10.

### Modified Example 7 of Embodiment

Hereinafter, Modified Example 7 of the embodiment will be described. Modified Example 7 of the embodiment is a modified example of Modified Example 5 of the embodiment. In the second output adjusting unit 14 according to Modified Example 5 of the embodiment, as described above, there are cases in which the power value of the DC power is adjusted by the second output adjusting unit 14 during adjustment of the power value of the DC power using the first output adjusting unit 24. Thus, a first output adjusting unit 24 according to Modified Example 7 of the embodiment may be configured such that a lowest target temperature among target temperatures that can be set by the first output adjusting unit 24 in accordance with an operation received by the operation receiving unit 23 is a temperature higher than the lower limit temperature described above. In this case, the first output adjusting unit 24 cannot configure the temperature of the casing of the toilet seat part 10 to be the lower-limit temperature or lower. As a result, the toilet seat device 1 can inhibit the second output adjusting unit 14 from starting to perform adjustment of the DC power in accordance with adjustment of the DC power using the first output adjusting unit 24.

Such control can be paraphrased as control in which the first output adjusting unit 24 adjusts the DC power such that the voltage value of the DC voltage supplied to the load LD is not less than a lower limit voltage value determined in advance. The lower limit voltage value is a voltage value higher than the voltage value of the reference voltage described above.

As described above, in the toilet seat device 1, the first output adjusting unit 24 adjusts the DC power such that the voltage value of the DC voltage supplied to the load LD is not less than a lower limit voltage value determined in advance, the second output adjusting unit 14 controls the DC/DC converter 13 based on a voltage signal output from the thermistor TS and the reference voltage, and the lower limit voltage value is a voltage value less than the voltage value of the reference voltage. In accordance with this, the toilet seat device 1 can adjust the power value of the DC power output from the rectification circuit 12 or the DC/DC converter 13 to the load LD while inhibiting blocking of adjustment of the power value of the DC power using the first output adjusting unit 24 of the main body part 20.

### Modified Example 8 of Embodiment

Hereinafter, Modified Example 8 of the embodiment will be described. Modified Example 8 of the embodiment may be a modified example of the embodiment or may be any one of Modified Examples 1 to 7 of the embodiment. Hereinafter, as one example, a case in which Modified Example 8 of the embodiment is a modified example of Modified Example 5 of the embodiment will be described. Hereinafter, as one example, a case in which the configuration of a main body part 20 according to Modified Example 8 of the embodiment is the configuration of the main body part 20 illustrated in FIG. 1, and the configuration of a toilet seat part 10 according to Modified Example 8 of the embodiment is the configuration of the toilet seat part 10 illustrated in FIG. 5 will be described.

In Modified Example 8 of the embodiment, the load LD is a nichrome wire heater. It is known that the nichrome wire heater has a small resistance value at the time of low temperature start-up. There are cases in which an excessive current flows at the time of low temperature start-up through a load having a small resistance value at the time of low temperature start-up like a nichrome wire heater. This is an event that may similarly occur when a resistance value is small at the time of low temperature start-up even in a case in which the load LD is a load other than a heater. The flowing of an excessive current through the load LD is an event that may cause a malfunction in the power supply P and is not desirable. However, at the time of low temperature start-up, control of drooping at least the voltage value of a DC voltage out of the voltage value of the DC voltage supplied to the load and the current value of a DC current supplied to the load LD in accordance with an increase in the current value of the DC current flowing through the load LD has a possibility of leading to a start-up malfunction of the toilet seat device 1, which is not desirable. Thus, in order to inhibit an occurrence of such a problem, the first output adjusting unit 24 or the second output adjusting unit 14 may be configured to perform constant voltage control in a case in which the current value of a DC current supplied to the load LD is less than a threshold TH2 determined in advance and perform constant power control in a case in which the current value of the DC current supplied to the load LD is the threshold TH2 determined in advance or more. The threshold TH2 is one example of a first threshold. The threshold TH2, for example, is a current value among current values of DC currents flowing though the load LD under constant voltage control that is acquired in a case in which DC power supplied to the load LD coincides with a rated output of the power supply P. In addition, the threshold TH2 may be a value that is less than this current value. In accordance with this, the first output adjusting unit 24 or the second output adjusting unit 14 can cause a current to flow through the load LD while inhibiting both causing of a malfunction in the power supply P and causing of a start-up malfunction in the toilet seat device 1 also at the time of low temperature start-up. Hereinafter, as one example, a case in which the second output adjusting unit 14 is configured to perform constant voltage control in a case in which the current value of the DC current supplied to the load LD is less than the threshold TH2 determined in advance and perform constant power control in a case in which the current value of the DC current supplied to the load LD is the threshold TH2 determined in advance or more will be described. For this reason, in Modified Example 8, as one example, a case in which the second output adjusting unit 14 includes a current detecting unit, which is not illustrated, detecting the current value of the DC current output from the DC/DC converter 13 to the load LD will be described.

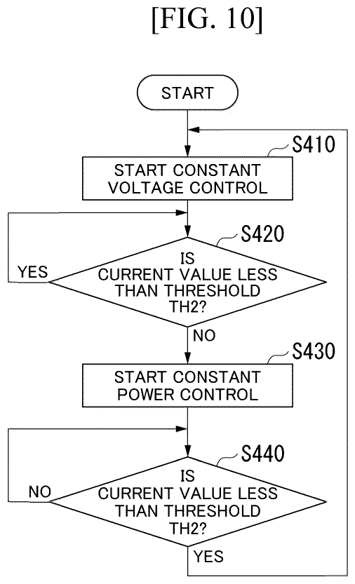

FIG. 10 is a diagram illustrating one example of a flow of the process of the second output adjusting unit 14 switching control of the DC/DC converter 13 between constant voltage control and constant power control. The toilet seat part 10 continuously performs the process of the flowchart illustrated in FIG. 10 in a period until power supply from the main body part 20 to the toilet seat part 10 stops after the power supply from the main body part 20 to the toilet seat part 10 starts.

After power supply from the main body part 20 to the toilet seat part 10 starts, the second output adjusting unit 14 starts constant voltage control of the DC/DC converter 13 (Step S410).

Next, the second output adjusting unit 14 determines whether or not the current value of a DC current detected by the current detecting unit included in the second output adjusting unit 14 is less than the threshold TH2 (Step S420).

In a case in which it is determined that the current value of the DC current detected by the current detecting unit included in the second output adjusting unit 14 is less than the threshold TH2 (Step S420—Yes), the second output adjusting unit 14 continues the constant voltage control started in Step S410 and causes the process to proceed to Step S420. Then, the second output adjusting unit 14 determines whether or not the current value of the DC current detected by this current detecting unit is less than the threshold TH2 again.

In a case in which it is determined that the current value of the DC current detected by the current detecting unit included in the second output adjusting unit 14 is the threshold TH2 or more (Step S420—No), the second output adjusting unit 14 ends the constant voltage control of the DC/DC converter 13 and starts constant power control of the DC/DC converter 13 (Step S430).

Next, the second output adjusting unit 14 determines whether or not the current value of the DC current detected by the current detecting unit included in the second output adjusting unit 14 is less than the threshold TH2 (Step S440).

In a case in which it is determined that the current value of the DC current detected by the current detecting unit included in the second output adjusting unit 14 is the threshold TH2 or more (Step S440—No), the second output adjusting unit 14 continues the constant power control started in Step S430 and causes the process to proceed to Step S440. Then, the second output adjusting unit 14 determines whether or not the current value of the DC current detected by this current detecting unit is less than the threshold TH2 again.

On the other hand, in a case in which it is determined that the current value of the DC current detected by the current detecting unit included in the second output adjusting unit 14 is less than the threshold TH2 (Step S440—Yes), the second output adjusting unit 14 causes the process to proceed to Step S410, ends the constant power control of the DC/DC converter 13, and starts the constant voltage control of the DC/DC converter 13 again.

As above, the second output adjusting unit 14 performs constant voltage control in a case in which the current value of the DC current supplied to the load LD is less than the threshold TH2 determined in advance and performs constant power control in a case in which the current value of the DC current supplied to the load LD is the threshold TH2 or more. In accordance with this, also at the time of low temperature start-up, the toilet seat device 1 can cause a current to flow through the load LD while inhibiting both causing of a malfunction in the power supply P and causing of a start-up malfunction in the toilet seat device 1.

In addition, in Modified Example 8 of the embodiment, in a case in which the toilet seat part 10 does not include the DC/DC converter 13 as illustrated in FIGS. 7, 8, and the like, the second output adjusting unit 14 controls the rectification circuit 12 using constant voltage control in Step S410 illustrated in FIG. 10. In addition, in Modified Example 8 of the embodiment, in this case, the second output adjusting unit 14 controls the rectification circuit 12 using constant power control in Step S430. In such a case, the second output adjusting unit 14 includes a current detecting unit, which is not illustrated, detecting the current value of the DC current output from the rectification circuit 12 to the load LD in place of a current detecting unit, which is not illustrated, detecting the current value of the DC current output from the DC/DC converter 13 to the load LD. In a case in which the toilet seat part 10 does not include the DC/DC converter 13, the second output adjusting unit 14 performs the processes of Steps S420 and S440 based on a current value detected by this current detecting unit.

In addition, in a case in which the first output adjusting unit 24 performs the process of the flowchart illustrated in FIG. 10, the first output adjusting unit 24, for example, includes a current detecting unit detecting a DC current output from the power supply P to the inverter 21 and determines whether or not a DC current detected by this current detecting unit is less than the threshold TH2 in Steps S420 and S440. In addition, in this case, the first output adjusting unit 24 starts control of the inverter 21 using constant voltage control in Step S410 and starts control of the inverter 21 using constant power control in Step S430.

### Modified Example 9 of Embodiment

Hereinafter, Modified Example 9 of the embodiment will be described. Modified Example 9 of the embodiment may be a modified example of the embodiment or may be any one of Modified Examples 1 to 7 of the embodiment. Hereinafter, as one example, a case in which Modified Example 9 of the embodiment is a modified example of Modified Example 5 of the embodiment will be described. Hereinafter, as one example, a case in which the configuration of a main body part 20 according to Modified Example 9 of the embodiment is the configuration of the main body part 20 illustrated in FIG. 1, and the configuration of a toilet seat part 10 according to Modified Example 9 of the embodiment is the configuration of the toilet seat part 10 illustrated in FIG. 5 will be described.

In Modified Example 9 of the embodiment, another processes solving both of the two problems described in Modified Example 8 of the embodiment is performed by a first output adjusting unit 24 or a second output adjusting unit 14. In Modified Example 9 of the embodiment, the first output adjusting unit 24 or the second output adjusting unit 14 may be configured to perform constant voltage control and, until a time T determined in advance elapses from a start-up timing, drooper at least one of the voltage value of the DC voltage supplied to the load LD and the current value of the DC current supplied to the load LD in a case in which the current value of the DC current supplied to the load LD becomes a threshold TH3 determined in advance or more, and drooper at least one of the voltage value of the DC voltage supplied to the load LD and the current value of the DC current supplied to the load LD in a case in which the current value of the DC current supplied to the load LD becomes a threshold TH4, which is smaller than the threshold TH3, or more after a time T elapses from the start-up timing. Hereinafter, as one example, a case in which the second output adjusting unit 14 is configured to perform constant voltage control and, until the time T elapses from the start-up timing, drooper at least one of the voltage value of the DC voltage supplied to the load LD and the current value of the DC current supplied to the load LD in a case in which the current value of the DC current supplied to the load LD becomes the threshold TH3 determined in advance or more, and drooper at least one of the voltage value of the DC voltage supplied to the load LD and the current value of the DC current supplied to the load LD in a case in which the current value of the DC current supplied to the load LD becomes the threshold TH4, which is smaller than the threshold TH3, or more after the time T elapses from the start-up timing will be described. For this reason, in Modified Example 9 of the embodiment, as one example, a case in which the second output adjusting unit 14 includes a current detecting unit, which is not illustrated, detecting the current value of the DC current output from the DC/DC converter 13 to the load LD will be described.

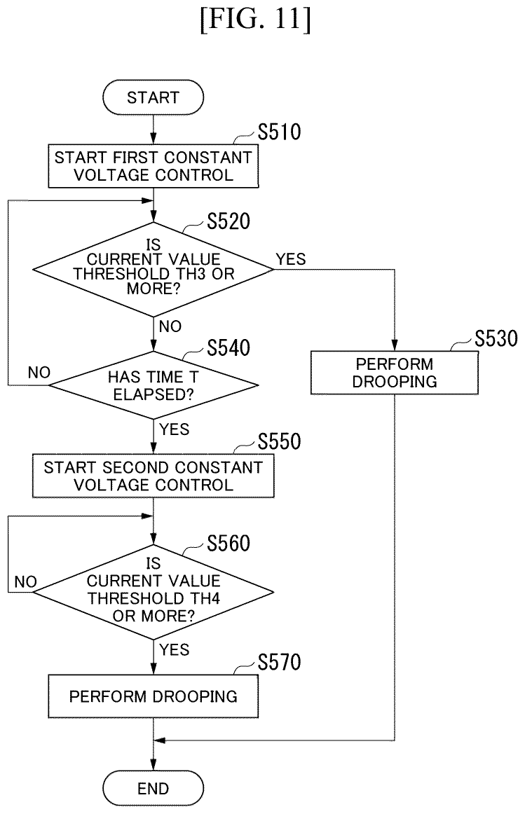

FIG. 11 is a diagram illustrating one example of a flow of the process of the second output adjusting unit 14 controlling the DC/DC converter 13 using constant voltage control. The toilet seat part 10 continuously performs the process of the flowchart illustrated in FIG. 10 in a period until power supply from the main body part 20 to the toilet seat part 10 stops after the power supply from the main body part 20 to the toilet seat part 10 starts.

After power supply from the main body part 20 to the toilet seat part 10 starts, the second output adjusting unit 14 starts first constant voltage control of the DC/DC converter 13 (Step S510). The first constant voltage control is control in which at least a voltage value out of the voltage value of the DC voltage supplied to the load LD and the current value of the DC current supplied to the load LD is drooped in a case in which it is determined that the current value of the DC current detected by the current detecting unit included in the second output adjusting unit 14 is the threshold TH3 or more. This drooping of at least one may be drooping of the voltage value and the current value according to a foldback current limiting characteristic or may be drooping of the voltage value according to a constant current characteristic. The threshold TH3 is one example of a second threshold. The threshold TH3, for example, is a current value of a case in which a power value of the DC power supplied to the load LD coincides with a maximum instantaneous output of the power supply P among current values of DC currents flowing though the load LD under constant voltage control. In other words, the first constant voltage control is constant voltage control capable of causing the power supply P to output a maximum instantaneous output.

Next, the second output adjusting unit 14 determines whether or not the current value of the DC current detected by the current detecting unit included in the second output adjusting unit 14 is the threshold TH3 or more (Step S520).

In a case in which it is determined that the current value of the DC current detected by the current detecting unit included in the second output adjusting unit 14 is less than the threshold TH3 (Step S520—No), the second output adjusting unit 14 determines whether or not the time T has elapsed from the timing at which the toilet seat part 10 started up (Step S540). Here, the time T, for example, is a longest time in which the power supply P continuously outputs a maximum instantaneous output but may be a time shorter than this longest time.

In a case in which it is determined that the time T has not elapsed from the timing at which the toilet seat part 10 started up (Step S540—No), the second output adjusting unit 14 causes the process to proceed to Step S520 and determines whether or not the current value of the DC current detected by the current detecting unit included in the second output adjusting unit 14 is the threshold TH3 or more again.

On the other hand, in a case in which it is determined that the time T has elapsed from the timing at which the toilet seat part 10 started up (Step S540—Yes), the second output adjusting unit 14 starts second constant voltage control of the DC/DC converter 13 (Step S550). The second constant voltage control is control for drooping at least a voltage value out of the voltage value of the DC voltage supplied to the load LD and the current value of the DC current supplied to the load LD in a case in which it is determined that the current value of the DC current detected by the current detecting unit included in the second output adjusting unit 14 is the threshold TH4 or more. This drooping of at least one may be drooping of the voltage value and the current value according to a foldback current limiting characteristic or may be drooping of the voltage value according to a constant current characteristic. The threshold TH4 is one example of a third threshold. The threshold TH4, for example, is a current value of a case in which a power value of the DC power supplied to the load LD coincides with a rated output of the power supply P among current values of DC currents flowing though the load LD under constant voltage control. In other words, the second constant voltage control is constant voltage control capable of causing the power supply P to output a DC current having a current value up to the rated output as its maximum.

Next, the second output adjusting unit 14 determines whether or not the current value of the DC current detected by the current detecting unit included in the second output adjusting unit 14 is the threshold TH4 or more (Step S560).

In a case in which it is determined that the current value of the DC current detected by the current detecting unit included in the second output adjusting unit 14 is less than the threshold TH4 (Step S560—No), the second output adjusting unit 14 causes the process to proceed to Step S560 and determines whether or not the current value of the DC current detected by the current detecting unit included in the second output adjusting unit 14 is the threshold TH4 or more again.

On the other hand, in a case in which it is determined that the current value of the DC current detected by the current detecting unit included in the second output adjusting unit 14 is the threshold TH4 or more (Step S560—Yes), the second output adjusting unit 14 droops at least voltage value out of the voltage value of the DC voltage supplied to the load LD and the current value of the DC current supplied to the load LD (Step S570) and ends the process of the flowchart illustrated in FIG. 11. In addition, in Step S570, after drooping at least the voltage value, the second output adjusting unit 14, for example, may perform an operation of sounding a buzzer indicating error after stopping the operation of the DC/DC converter 13, turning on light indicating error after stopping the operation of the DC/DC converter 13, or the like or may not perform any operation.

On the other hand, in a case in which it is determined that the current value of the DC current detected by the current detecting unit included in the second output adjusting unit 14 is the threshold TH3 or more (Step S520—Yes), the second output adjusting unit 14 droops at least a voltage value out of the voltage value of the DC voltage supplied to the load LD and the current value of the DC current supplied to the load LD (Step S530) and ends the process of the flowchart illustrated in FIG. 11. In addition, in Step S530, after drooping at least the voltage value, the second output adjusting unit 14, for example, may perform an operation of sounding a buzzer indicating error after stopping the operation of the DC/DC converter 13, turning on light indicating error after stopping the operation of the DC/DC converter 13, or the like or may not perform any operation.

As above, the second output adjusting unit 14 performs constant voltage control and, until the time T determined in advance has elapsed from the start-up timing, in a case in which the current value of the DC current supplied to the load LD becomes the threshold TH3 determined in advance or more, droops at least a voltage value out of the voltage value of the DC voltage supplied to the load LD and the current value of the DC current supplied to the load LD and, after the time T has elapsed from the start-up timing, droops at least a voltage value out of the voltage value of the DC voltage supplied to the load LD and the current value of the DC current supplied to the load LD in a case in which the current value of the DC current supplied to the load LD becomes the threshold TH4, which is smaller than the threshold TH3, or more. In accordance with this, also at the time of low temperature start-up, the toilet seat device 1 according to Modified Example 9 of the embodiment can cause a current to flow through the load LD while inhibiting both causing of a malfunction in the power supply P and causing of a start-up malfunction in the toilet seat device 1.

In addition, in Modified Example 9 of the embodiment, in a case in which the toilet seat part 10 does not include the DC/DC converter 13 as illustrated in FIGS. 7, 8, and the like, the second output adjusting unit 14 controls the rectification circuit 12 using the first constant voltage control in Step S510 illustrated in FIG. 11. In addition, in Modified Example 9 of the embodiment, in this case, the second output adjusting unit 14 controls the rectification circuit 12 using the second constant voltage control in Step S550. In such a case, the second output adjusting unit 14 includes a current detecting unit, which is not illustrated, detecting the current value of the DC current output from the rectification circuit 12 to the load LD in place of a current detecting unit, which is not illustrated, detecting the current value of the DC current output from the DC/DC converter 13 to the load LD. In a case in which the toilet seat part 10 does not include the DC/DC converter 13, the second output adjusting unit 14 performs the processes of Steps S520 and S560 based on a current value detected by this current detecting unit. In this case, the second output adjusting unit 14 controls the rectification circuit 12 in the processes of Steps S530 and S570.

In addition, in a case in which the first output adjusting unit 24 performs the process of the flowchart illustrated in FIG. 11, the first output adjusting unit 24, for example, includes a current detecting unit detecting a DC current output from the power supply P to the inverter 21, determines whether or not a DC current detected by this current detecting unit is less than the threshold TH3 in Step S520, and determines whether or not the DC current detected by this current detecting unit is less than the threshold TH4 in Step S560. In addition, in this case, the first output adjusting unit 24 starts control of the inverter 21 using the first constant voltage control in Step S510 and starts control of the inverter 21 using the second constant power control in Step S550. Furthermore, in this case, the first output adjusting unit 24 controls the inverter 21 in the processes of Steps S530 and S570.

In addition, the matters described above may be combined in any form.

### Supplementary Note

[1]

A toilet seat device including: a toilet seat part; and a main body part in which the toilet seat part is mounted to be attachable and detachable, in which the main body part transmits electric power to the toilet seat part using wireless power transmission, the toilet seat part receives electric power from the main body part using wireless power transmission and includes a load to which the electric power received from the main body part is supplied, and at least one of the toilet seat part and the main body part includes an output adjusting unit adjusting a power value of electric power output to the load by the toilet seat part without using wireless communication between the toilet seat part and the main body part.

[2]

In the toilet seat device described in [1], the main body part includes a first output adjusting unit adjusting the power value, an inverter converting a DC voltage supplied from a power supply into an AC voltage, and a power transmitting unit transmitting the AC voltage supplied from the inverter to the toilet seat part using wireless power transmission, the output adjusting unit includes the first output adjusting unit, the inverter outputs the AC voltage after conversion to the power transmitting unit, and the first output adjusting unit controls the inverter in accordance with a received operation and adjusts the power value.

[3]

In the toilet seat device described in [1], the main body part includes a first output adjusting unit adjusting the power value, an inverter converting a DC voltage supplied from a power supply into an AC voltage, a power transmitting unit transmitting the AC voltage supplied from the inverter to the toilet seat part using wireless power transmission, a power supply terminal to which a DC voltage is supplied from a power supply, and a switch performing switching of a conduction state between the power supply terminal and the inverter in accordance with control using the first output adjusting unit, the output adjusting unit includes the first output adjusting unit, the inverter outputs the AC voltage after conversion to the power transmitting unit, and the first output adjusting unit controls the switch in accordance with a received operation and adjusts the power value.

[4]

In the toilet seat device described in [1], the toilet seat part includes a second output adjusting unit adjusting the power value, a power receiving unit receiving an AC voltage from the main body part using wireless power transmission, a rectification circuit converting an AC voltage received by the power receiving unit into a DC voltage, a DC/DC converter transforming a DC voltage supplied from the rectification circuit, and a thermistor connected between the DC/DC converter and the load, the output adjusting unit includes the second output adjusting unit, the DC/DC converter outputs a DC voltage after transformation to the load, and the second output adjusting unit controls the DC/DC converter based on a voltage signal output from the thermistor and adjusts the power value.

[5]

In the toilet seat device described in [1], the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load, the output adjusting unit includes the second output adjusting unit, the rectification circuit includes four switching elements forming bridge connection, converts an AC voltage received by the power receiving unit into a DC voltage using switching of the four switching elements, and outputs the DC voltage after conversion to the load, and the second output adjusting unit controls the four switching elements based on a voltage signal supplied from the thermistor and adjusts the power value.

[6]

In the toilet seat device described in [1], the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load, the output adjusting unit includes the second output adjusting unit, the power receiving unit includes a power reception-side resonant circuit and a switching element changing a resonance frequency of the power reception-side resonant circuit, and the second output adjusting unit controls the switching element based on a voltage signal supplied from the thermistor and adjusts the power value.

[7]

In the toilet seat device described in [2] or [3], the toilet seat part includes a second output adjusting unit adjusting the power value, a power receiving unit receiving an AC voltage from the main body part using wireless power transmission, a rectification circuit converting an AC voltage received by the power receiving unit into a DC voltage, a DC/DC converter transforming a DC voltage supplied from the rectification circuit, and a thermistor connected between the DC/DC converter and the load, the output adjusting unit includes the second output adjusting unit, the DC/DC converter outputs a DC voltage after transformation to the load, and the second output adjusting unit controls the DC/DC converter based on a voltage signal output from the thermistor and adjusts the power value.

[8]

In the toilet seat device described in [2] or [3], the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load, the output adjusting unit includes the second output adjusting unit, the rectification circuit includes four switching elements forming bridge connection, converts an AC voltage received by the power receiving unit into a DC voltage using switching of the four switching elements, and outputs the DC voltage after conversion to the load, and the second output adjusting unit controls the four switching elements based on a voltage signal supplied from the thermistor and adjusts the power value.

[9]

In the toilet seat device described in [2] or [3], the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load, the output adjusting unit includes the second output adjusting unit, the power receiving unit includes a power reception-side resonant circuit and a switching element changing a resonance frequency of the power reception-side resonant circuit, and the second output adjusting unit controls the switching element based on a voltage signal supplied from the thermistor and adjusts the power value.

[10]

In the toilet seat device described in [7], the first output adjusting unit adjusts the electric power output to the load by the toilet seat part such that a voltage value of the DC voltage supplied to the load is not less than a lower limit voltage value determined in advance, the second output adjusting unit controls the DC/DC converter based on a voltage signal output from the thermistor and a reference voltage, and the lower limit voltage value is a voltage value less than a voltage value of the reference voltage.

[11]

In the toilet seat device described in [8], the first output adjusting unit adjusts the electric power output to the load by the toilet seat part such that a voltage value of the DC voltage supplied to the load is not less than a lower limit voltage value determined in advance, the second output adjusting unit controls the four switching elements based on a voltage signal output from the thermistor and a reference voltage, and the lower limit voltage value is a voltage value less than a voltage value of the reference voltage.

[12]

In the toilet seat device described in [9], the first output adjusting unit adjusts the electric power output to the load by the toilet seat part such that a voltage value of the DC voltage supplied to the load is not less than a lower limit voltage value determined in advance, the second output adjusting unit controls the switching element based on a voltage signal output from the thermistor and a reference voltage, and the lower limit voltage value is a voltage value less than a voltage value of the reference voltage.

[13]

In the toilet seat device described in any one of [7] to [12], the second output adjusting unit is capable of detecting that adjustment of the power value has been performed by the first output adjusting unit and does not perform adjustment of the power value based on the voltage signal in a case in which it is detected that the adjustment of the power value has been performed by the first output adjusting unit.

[14]

In the toilet seat device described in any one of [1] to [13], the output adjusting unit performs constant voltage control in a case in which a current value of the DC current supplied to the load is less than a first threshold determined in advance and performs constant power control in a case in which the current value of the DC current supplied to the load is the first threshold or more.

[15]

In the toilet seat device described in any one of [1] to [13], the output adjusting unit performs constant voltage control, until a time determined in advance elapses from a start-up timing, in a case in which a current value of the DC current supplied to the load becomes a second threshold determined in advance or more, droops at least a voltage value of the DC voltage supplied to the load out of the voltage value of the DC voltage supplied to the load and a current value of the DC current supplied to the load, and, after the time elapses from the timing, in a case in which the current value of the DC current supplied to the load becomes a third threshold, which is less than the second threshold, or more, droops at least the voltage value of the DC voltage supplied to the load out of the voltage value of the DC voltage supplied to the load and the current value of the DC current supplied to the load.

[16]

In the toilet seat device described in any one of [1] to [15], the load is a heater warming a casing of the toilet seat part.

[17]

A toilet seat device including: a toilet seat part; and a main body part in which the toilet seat part is mounted to be attachable and detachable, in which the main body part transmits electric power to the toilet seat part using wireless power transmission, and the toilet seat part receives electric power from the main body part using wireless power transmission and includes a load to which the electric power received from the main body part is supplied.

As above, although the embodiment of the present disclosure has been described in detail with reference to the drawings, a specific configuration is not limited to this embodiment, and changes, substitutions, omissions, and the like may be made without departing the concept of the present disclosure.

In addition, a program used for realizing the function of an arbitrary constituent part of the device described above may be recorded on a computer-readable recording medium, and a computer system may be caused to read and execute the program. Here, this device, for example, is the toilet seat device 1, the toilet seat part 10, the main body part 20, or the like. The “computer system” described here includes an operating system (OS) and hardware such as peripherals. The “computer-readable recording medium” represents portable medium such as a flexible disk, a magneto-optical disk, a ROM, a compact disk (CD)-ROM, or the like and a storage device such as a hard disk built into a computer system or the like. In addition, the “computer-readable recording medium” is assumed to include a medium storing a program for a predetermined time such as an internal volatile memory of a computer system serving as a server or a client in a case in which the program is transmitted through a network such as the Internet or a communication line such as a telephone line.

In addition, the program described above may be transmitted from a computer system storing the program in a storage device or the like to another computer system through a transmission medium or using transmission waves in a transmission medium. Here, the “transmission medium” transmitting the program represents a medium having a function of transmitting information such as a network including the Internet and the like or a communication line including a telephone line and the like.

In addition, the program described above may be used for realizing some of the functions described above. Furthermore, the program described above may be a program realizing the functions described above by being combined with a program recorded in the computer system in advance, a so-called differential file or differential program.

### REFERENCE SIGNS LIST

1 Toilet seat device
10 Toilet seat part
11 Power receiving unit
12 Rectification circuit
13 DC/DC converter
14 Second output adjusting unit
20 Main body part
21 Inverter
22 Power transmitting unit
23 Operation receiving unit
24 First output adjusting unit
25 Switch
C1 Capacitor
C2 Capacitor
CL Power receiving coil
CP Comparator
LD Load
OS power reception-side resonant circuit
P Power supply
P2 Power supply
R Resistance element
SW Switching element
TM Power supply terminal
TN Negative electrode-side power supply terminal
TP Positive electrode-side power supply terminal
TS Thermistor

1. A toilet seat device comprising:
a toilet seat part; and
a main body part on which the toilet seat part is mounted to be attachable and detachable,
wherein the main body part transmits electric power to the toilet seat part using wireless power transmission,
the toilet seat part receives electric power from the main body part using wireless power transmission and includes a load to which the electric power received from the main body part is supplied, and
at least one of the toilet seat part and the main body part includes an output adjusting unit adjusting a power value of electric power output to the load by the toilet seat part without using wireless communication between the toilet seat part and the main body part.

2. The toilet seat device according to claim 1,
wherein the main body part includes a first output adjusting unit adjusting the power value, an inverter converting a DC voltage supplied from a power supply into an AC voltage, and a power transmitting unit transmitting the AC voltage supplied from the inverter to the toilet seat part using wireless power transmission,
the output adjusting unit includes the first output adjusting unit,
the inverter outputs the AC voltage after conversion to the power transmitting unit, and
the first output adjusting unit controls the inverter in accordance with a received operation and adjusts the power value.

3. The toilet seat device according to claim 1,
wherein the main body part includes a first output adjusting unit adjusting the power value, an inverter converting a DC voltage supplied from a power supply into an AC voltage, a power transmitting unit transmitting the AC voltage supplied from the inverter to the toilet seat part using wireless power transmission, a power supply terminal to which a DC voltage is supplied from a power supply, and a switch performing switching of a conduction state between the power supply terminal and the inverter in accordance with control using the first output adjusting unit,
the output adjusting unit includes the first output adjusting unit,
the inverter outputs the AC voltage after conversion to the power transmitting unit, and
the first output adjusting unit controls the switch in accordance with a received operation and adjusts the power value.

4. The toilet seat device according to claim 1,
wherein the toilet seat part includes a second output adjusting unit adjusting the power value, a power receiving unit receiving an AC voltage from the main body part using wireless power transmission, a rectification circuit converting an AC voltage received by the power receiving unit into a DC voltage, a DC/DC converter transforming a DC voltage supplied from the rectification circuit, and a thermistor connected between the DC/DC converter and the load,
the output adjusting unit includes the second output adjusting unit,
the DC/DC converter outputs the DC voltage after transformation to the load, and
the second output adjusting unit controls the DC/DC converter based on a voltage signal output from the thermistor and adjusts the power value.

5. The toilet seat device according to claim 1,
wherein the toiled seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load,
the output adjusting unit includes the second output adjusting unit,
the rectification circuit includes four switching elements forming bridge connection, converts an AC voltage received by the power receiving unit into a DC voltage using switching of the four switching elements, and outputs the DC voltage after conversion to the load, and
the second output adjusting unit controls the four switching elements based on a voltage signal supplied from the thermistor and adjusts the power value.

6. The toilet seat device according to claim 1,
wherein the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load,
the output adjusting unit includes the second output adjusting unit,
the power receiving unit includes a power reception-side resonant circuit and a switching element changing a resonance frequency of the power reception-side resonant circuit, and
the second output adjusting unit controls the switching element based on a voltage signal supplied from the thermistor and adjusts the power value.

7. The toilet seat device according to claim 2,
wherein the toiled seat part includes a second output adjusting unit adjusting the power value, a power receiving unit receiving an AC voltage from the main body part using wireless power transmission, a rectification circuit converting an AC voltage received by the power receiving unit into a DC voltage, a DC/DC converter transforming a DC voltage supplied from the rectification circuit, and a thermistor connected between the DC/DC converter and the load,
the output adjusting unit includes the second output adjusting unit,
the DC/DC converter outputs a DC voltage after transformation to the load, and
the second output adjusting unit controls the DC/DC converter based on a voltage signal output from the thermistor and adjusts the power value.

8. The toilet seat device according to claim 2,
wherein the toilet seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load,
the output adjusting unit includes the second output adjusting unit,
the rectification circuit includes four switching elements forming bridge connection, converts an AC voltage received by the power receiving unit into a DC voltage using switching of the four switching elements, and outputs the DC voltage after conversion to the load, and
the second output adjusting unit controls the four switching elements based on a voltage signal supplied from the thermistor and adjusts the power value.

9. The toilet seat device according to claim 2,
wherein the toiled seat part includes a second output adjusting unit adjusting the power value, a power receiving unit receiving an AC voltage from the main body part using wireless power transmission, a rectification circuit converting an AC voltage received by the power receiving unit into a DC voltage, and a thermistor connected between the rectification circuit and the load,
the output adjusting unit includes the second output adjusting unit,
the power receiving unit includes a power reception-side resonant circuit and a switching element changing a resonance frequency of the power reception-side resonant circuit, and
the second output adjusting unit controls the switching element based on a voltage signal supplied from the thermistor and adjusts the power value.

10. The toilet seat device according to claim 7,
wherein the first output adjusting unit adjusts the electric power output to the load by the toilet seat part such that a voltage value of the DC voltage supplied to the load is not less than a lower limit voltage value determined in advance,
the second output adjusting unit controls the DC/DC converter based on a voltage signal output from the thermistor and a reference voltage, and
the lower limit voltage value is a voltage value less than a voltage value of the reference voltage.

11. The toilet seat device according to claim 8,
wherein the first output adjusting unit adjusts the electric power output to the load by the toilet seat part such that a voltage value of the DC voltage supplied to the load is not less than a lower limit voltage value determined in advance,
the second output adjusting unit controls the four switching elements based on a voltage signal output from the thermistor and a reference voltage, and
the lower limit voltage value is a voltage value less than a voltage value of the reference voltage.

12. The toilet seat device according to claim 9,
wherein the first output adjusting unit adjusts the electric power output to the load by the toilet seat part such that a voltage value of the DC voltage supplied to the load is not less than a lower limit voltage value determined in advance,
the second output adjusting unit controls the switching element based on a voltage signal output from the thermistor and a reference voltage, and
the lower limit voltage value is a voltage value less than a voltage value of the reference voltage.

13. The toilet seat device according to claim 7, wherein the second output adjusting unit is capable of detecting that adjustment of the power value has been performed by the first output adjusting unit and does not perform adjustment of the power value based on the voltage signal in a case in which it is detected that the adjustment of the power value has been performed by the first output adjusting unit.

14. The toilet seat device according to claim 8, wherein the second output adjusting unit is capable of detecting that adjustment of the power value has been performed by the first output adjusting unit and does not perform adjustment of the power value based on the voltage signal in a case in which it is detected that the adjustment of the power value has been performed by the first output adjusting unit.

15. The toilet seat device according to claim 9, wherein the second output adjusting unit is capable of detecting that adjustment of the power value has been performed by the first output adjusting unit and does not perform adjustment of the power value based on the voltage signal in a case in which it is detected that the adjustment of the power value has been performed by the first output adjusting unit.

16. The toilet seat device according to claim 1, wherein the output adjusting unit performs constant voltage control in a case in which a current value of the DC current supplied to the load is less than a first threshold determined in advance and performs constant power control in a case in which the current value of the DC current supplied to the load is the first threshold or more.

17. The toilet seat device according to claim 1, wherein the output adjusting unit performs constant voltage control, until a time determined in advance elapses from a start-up timing, in a case in which a current value of the DC current supplied to the load becomes a second threshold determined in advance or more, droops at least a voltage value of the DC voltage supplied to the load out of the voltage value of the DC voltage supplied to the load and a current value of the DC current supplied to the load, and after the time elapses from the timing, in a case in which the current value of the DC current supplied to the load becomes a third threshold, which is less than the second threshold, or more, droops at least the voltage value of the DC voltage supplied to the load out of the voltage value of the DC voltage supplied to the load and the current value of the DC current supplied to the load.

18. The toilet seat device according to claim 1, wherein the load is a heater warming a casing of the toilet seat part.
